(19) United States
(12) Patent Application Publication
(10) Pub. No.: US 2013/0223838 A1
(43) Pub. Date: Aug. 29, 2013

(54) TRANSMITTING APPARATUS AND TRANSMITTING METHOD

(71) Applicant: Fujitsu Optical Components Limited, Kawasaki-shi (JP)

(72) Inventors: Masakazu Horishita, Kawasaki (JP); Shinichi Sakuramoto, Kawasaki (JP)

(73) Assignee: Fujitsu Optical Components Limited, Kawasaki-shi (JP)

(21) Appl. No.: 13/688,624

(22) Filed: Nov. 29, 2012

(30) Foreign Application Priority Data
Feb. 29, 2012 (JP) 2012-044690

(51) Int. Cl. H04B 10/071

(52) U.S. Cl. CPC H04B 10/071
USPC 398/13; 398/16

(57) ABSTRACT

A transmitting apparatus connected via an optical branching apparatus to an optical communication device group includes a control unit that for each periodic transmission period including a first transmission period with a test period in which the optical communication device group is not allowed to transmit optical signals and a second transmission period without the test period, allows the optical communication device group to transmit the optical signals during a period different from the test period; a test light sending unit that sends test light to the optical branching apparatus during the test period; a light receiving unit that receives optical signals transmitted from the optical communication device group, and reflected light of the sent test light; a measuring unit that measures intensity of the reflected light received at different elapsed times after the test light is sent; and an output unit that outputs information based on the measured intensity.

### CROSS REFERENCE TO RELATED APPLICATIONS

This application is based upon and claims the benefit of priority of the prior Japanese Patent Application No. 2012-044690, filed on Feb. 29, 2012, the entire contents of which are incorporated herein by reference.

### FIELD

The embodiments discussed herein are related to a transmitting apparatus and a transmitting method.

### BACKGROUND

A passive optical network (PON) system is recently utilized as an optical subscriber system. In the PON system, for example, an optical line terminal (OLT: provider station side terminal) disposed on the provider station side is connected via a star coupler to an optical network unit (ONU: subscriber side terminal) on the subscriber side.

In the PON system, a downlink optical signal from the OLT to the ONU and an uplink optical signal from the ONU to the OLT are concurrently transmitted at different wavelengths. For example, in the downlink transmission, optical signals of a wavelength λ1 to ONUs are transmitted as continuous signals. In the uplink transmission, each ONU transmits an optical signal of a wavelength λ2 (≠λ1) in a burst mode so as not to collision with the optical signals from the other ONUs.

An optical time domain reflectometer (OTDR) for diagnosing line disconnection etc., in a transmission line is known in the PON system (see, e.g., Japanese Laid-Open Patent Publication No. 2011-24095). For the OTDR, for example, the OLT sends test light of a wavelength λ3 different from the wavelengths (λ1 and λ2) of the uplink and downlink optical signals to a transmission line and the OLT measures the reflected light of the test light so as to diagnose the state of the transmission line without stopping the uplink and downlink transmissions.

However, the conventional technique described above has a problem in that a transmitting apparatus on the provider station side is increased in apparatus scale due to a mechanism of separating the reflected light of the sent test light of the wavelength λ3 from the uplink signal of the wavelength λ2 from the subscriber side.

### SUMMARY

According to an aspect of an embodiment, a transmitting apparatus connected via an optical branching apparatus to an optical communication device group, includes a control unit that for each periodic transmission period including a first transmission period with a test period in which the optical communication device group is not allowed to transmit optical signals and a second transmission period without the test period, allows the optical communication device group to transmit the optical signals during a period in the periodic transmission period and different from the test period; a test light sending unit that sends test light to the optical branching apparatus during the test period; a light receiving unit that receives the optical signals transmitted from the optical communication device group during the period different from the test period, and receives reflected light of the test light sent by the test light sending unit during the test period; a measuring unit that measures intensity of the reflected light received by the light receiving unit at different elapsed times after the sending of the test light during the test period; and an output unit that outputs information based on the intensity measured at the elapsed times by the measuring unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a diagram of an example of a transmission system according to an embodiment (not during test);

FIG. 1B is a diagram of an example of the transmission system (during test);

FIG. 1C is a diagram of a modification of the transmission system (not during test);

FIG. 1D is a diagram of a modification of the transmission system (during test);

FIG. 2A is a diagram of an example of a PON system and downlink signals;

FIG. 2B is a diagram of an example of the PON system and uplink signals;

FIG. 3 is a sequence diagram of an example of ranging;

FIG. 4 is a diagram of an example of an uplink signal frame;

FIG. 5 is a diagram of an example of a configuration of an OLT;

FIG. 6 is a diagram of an example of a configuration of a main signal sending unit;

FIG. 7 is a diagram of an example of a configuration of a test light sending unit;

FIG. 8A is a diagram of an example of a configuration of a receiving unit;

FIG. 8B is a diagram of an example of a configuration of a test light intensity measuring unit depicted in FIG. 8A;

FIG. 9 is a diagram of a modification of the receiving unit;

FIG. 10 is a diagram of an example of a configuration of a frame control unit;

FIG. 11A is a diagram of a first configuration example of an uplink frame including an OTDR area;

FIG. 11B is a diagram of a second configuration example of an uplink frame including an OTDR area;

FIG. 12A is a diagram of a configuration example of an uplink frame including a relatively short OTDR area;

FIG. 12B is a diagram of a configuration example of an uplink frame including a relatively long OTDR area;

FIG. 13 is a diagram of an example of a configuration of a faulty-transmission-line identifying unit;

FIG. 14 is a diagram of a modification of the faulty-transmission-line identifying unit;

FIG. 15 is a diagram of an example of a configuration of a diagnosing unit;

FIG. 16 is a flowchart of an example of operation of the OLT;

FIG. 17 is a diagram of a modification of a main signal receiving unit;

FIG. 18A is a diagram of an example of operation timing of the OLT at a normal time;

FIG. 18B is a diagram of an example of operation timing of the OLT at a time of detection of failure;

FIG. 19A is a diagram of an example of an intensity measurement result of reflected light at the normal time;

FIG. 19B is a diagram of an example of an intensity measurement result of reflected light at the time of detection of failure; and

FIG. 20 is a diagram of a modification of a transmitting apparatus.

### DESCRIPTION OF EMBODIMENTS

Preferred embodiments of the present invention will be explained with reference to the accompanying drawings.

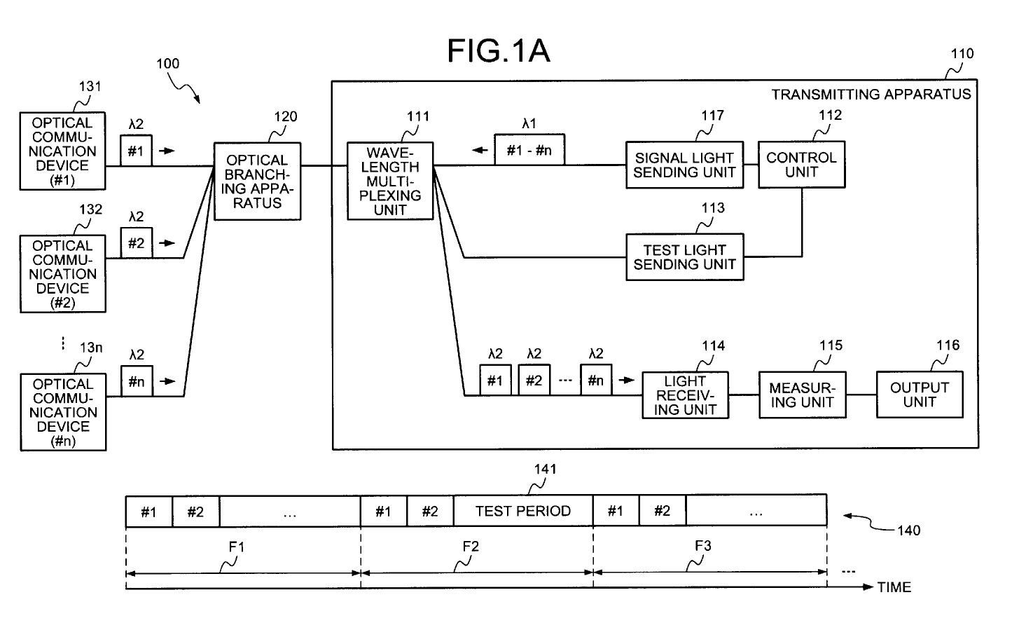

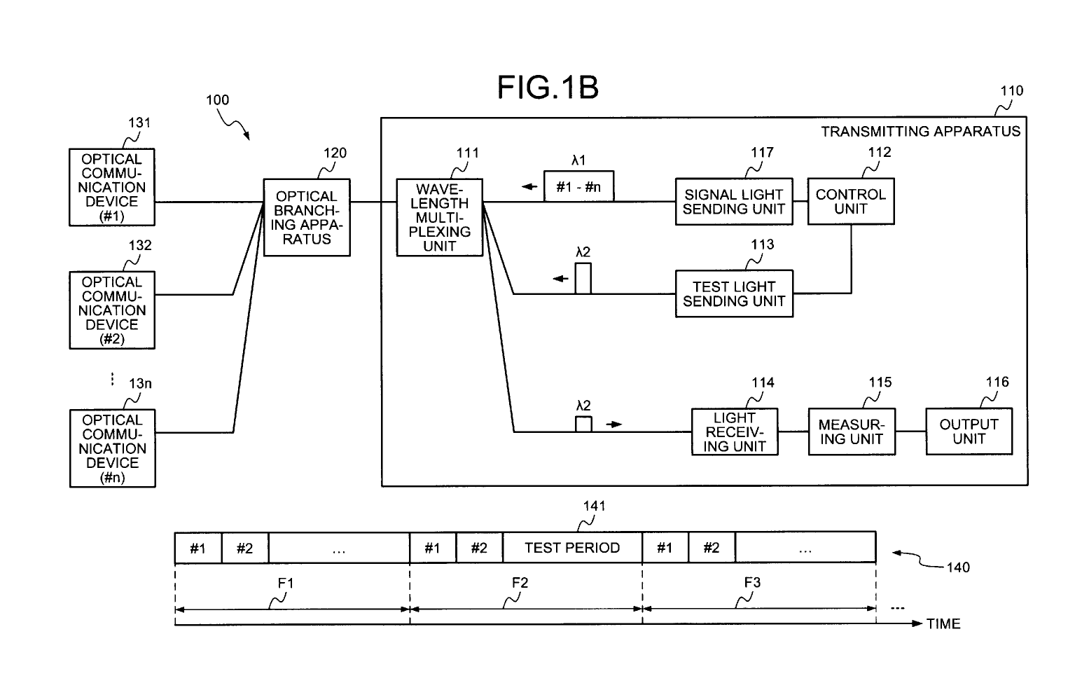

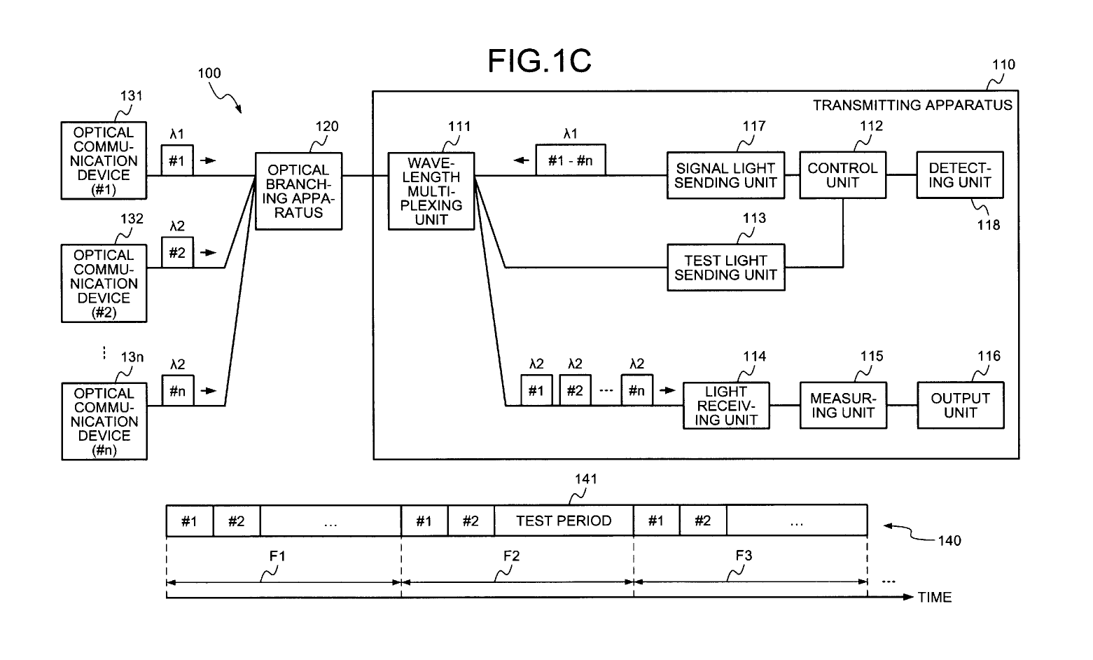

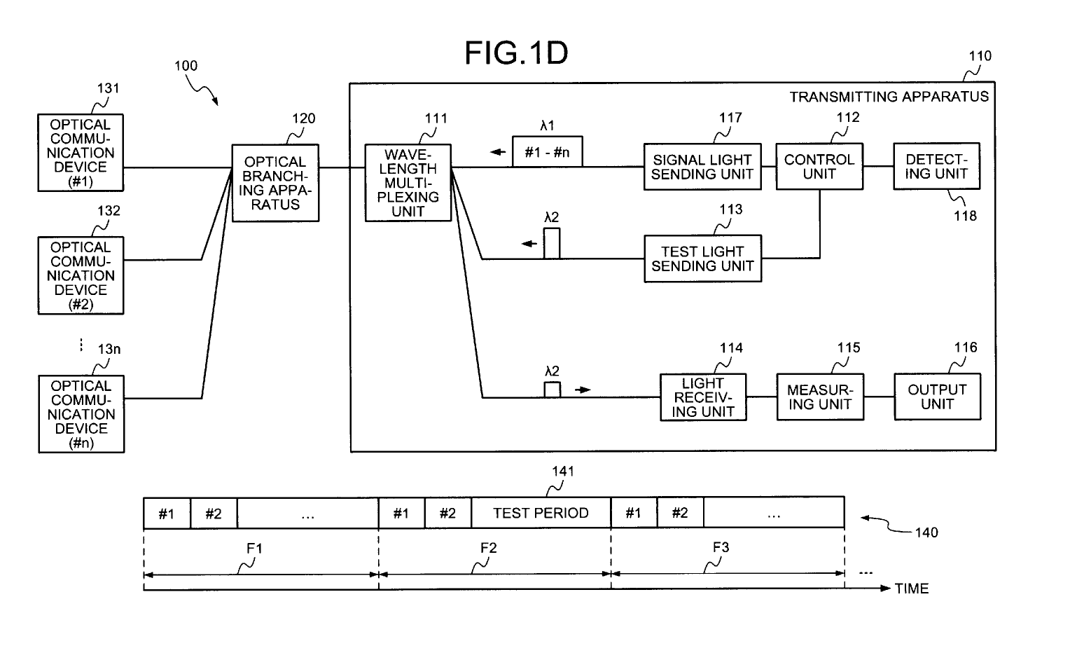

FIG. 1A is a diagram of an example of a transmission system according to the embodiment (not during test). FIG. 1B is a diagram of an example of the transmission system according to the embodiment (during test). As depicted in FIGS. 1A and 1B, a transmission system 100 according to the embodiment includes a transmitting apparatus 110, an optical branching apparatus 120, n (n is a natural number greater than or equal to 2) optical communication devices 131 to 13n (an optical communication device group).

The transmitting apparatus 110 is connected one-to-n via the optical branching apparatus 120 to the optical communication devices 131 to 13n. The transmitting apparatus 110 is connected to the optical branching apparatus 120 through an optical fiber, for example. The transmitting apparatus 110 is connected to the optical communication devices 131 to 13n through optical fibers, for example.

The transmitting apparatus 110 performs, for example, bidirectional optical communication with each of the optical communication devices 131 to 13n. For example, the optical communication from the transmitting apparatus 110 to the optical communication devices 131 to 13n is performed by using optical signals of a wavelength λ1 (first wavelength). The optical communication from the optical communication devices 131 to 13n to the transmitting apparatus 110 is performed by using optical signals of a wavelength λ2 (second wavelength) different from the wavelength λ1.

A transmission timing 140 indicates the transmission timing of the optical communication from the optical communication devices 131 to 13n to the transmitting apparatus 110. As indicated by the transmission timing 140, periodic frames (F1, F2, F3, . . . ) are set in the optical communication from the optical communication devices 131 to 13n to the transmitting apparatus 110. A frame is a transmission period serving as a unit of periodic transmission.

Each of the optical communication devices 131 to 13n sends an optical signal (#1 to #n) to the transmitting apparatus 110 for each frame according to the transmission timing given from the transmitting apparatus 110. The optical signals sent by the optical communication devices 131 to 13n are received via the optical branching apparatus 120 by the transmitting apparatus 110.

The transmitting apparatus 110 includes a wavelength multiplexing unit 111, a control unit 112, a test light sending unit 113, a light receiving unit 114, a measuring unit 115, an output unit 116, and a signal light sending unit 117. The wavelength multiplexing unit 111 wavelength-multiplexes and sends the light sent from the signal light sending unit 117 and the test light sending unit 113 to the optical branching apparatus 120. Of the light sent from the optical branching apparatus 120, the wavelength multiplexing unit 111 sends the light of the wavelength λ2 to the light receiving unit 114.

The control unit 112 sets a test period 141 such that the periodic frames include a frame with the test period 141 (a first transmission period) and a frame without the test period 141 (a second transmission period). The test period 141 is a period in which no optical signal is allowed to be transmitted from the optical communication devices 131 to 13n to the transmitting apparatus 110, so as to test the transmission lines to the optical communication devices 131 to 13n.

The control unit 112 provides control, for each frame, to allow the optical communication devices 131 to 13n to transmit optical signals during a period of the frame different from the test period 141 in the frame. Therefore, for example, a period for allowing the optical communication devices 131 to 13n to transmit optical signals in a frame with the test period 141 (e.g., F2) is made shorter than a period for allowing the optical communication devices 131 to 13n to transmit optical signals in a frame without the test period 141 (e.g., F1 or F3).

For example, the control unit 112 controls the transmission timings of optical signals of the optical communication devices 131 to 13n such that the optical signals from the optical communication devices 131 to 13n are received by the light receiving unit 114 at respectively different timings. To control the transmission timings of optical signals of the optical communication devices 131 to 13n, the control unit 112 stores into signals sent by the signal light sending unit 117, for example, information indicating the transmission timings of optical signals of the optical communication devices 131 to 13n.

The control unit 112 controls the test light sending unit 113 such that the test light is sent during the set test period 141. For example, the control unit 112 controls the test light sending unit 113 such that the test light is sent at the start time of the set test period 141.

The test light sending unit 113 sends the test light of the wavelength λ2 to the wavelength multiplexing unit 111 under the control of the control unit 112. The test light sent by the test light sending unit 113 is propagated via the wavelength multiplexing unit 111 and the optical branching apparatus 120 to the optical communication devices 131 to 13n. The test light is reflected by a portion having a failure such as line disconnection occurring in the transmission lines from the transmitting apparatus 110 to the optical communication devices 131 to 13n and the reflected light of the test light returns to the transmitting apparatus 110.

The light receiving unit 114 receives the light output from the wavelength multiplexing unit 111. Therefore, the light receiving unit 114 receives the optical signals (#1 to #n) of the wavelength λ2 transmitted from the optical communication devices 131 to 13n, during a period different from the test period 141 set by the control unit 112. The light receiving unit 114 receives the reflected light of the test light sent by the test light sending unit 113, during the test period 141 set by the control unit 112.

The measuring unit 115 measures the intensity of the reflected light received by the light receiving unit 114 during the test period 141 set by the control unit 112 at elapsed times after the sending of the test light from the test light sending unit 113. The measuring unit 115 gives the intensity measured at elapsed times to the output unit 116.

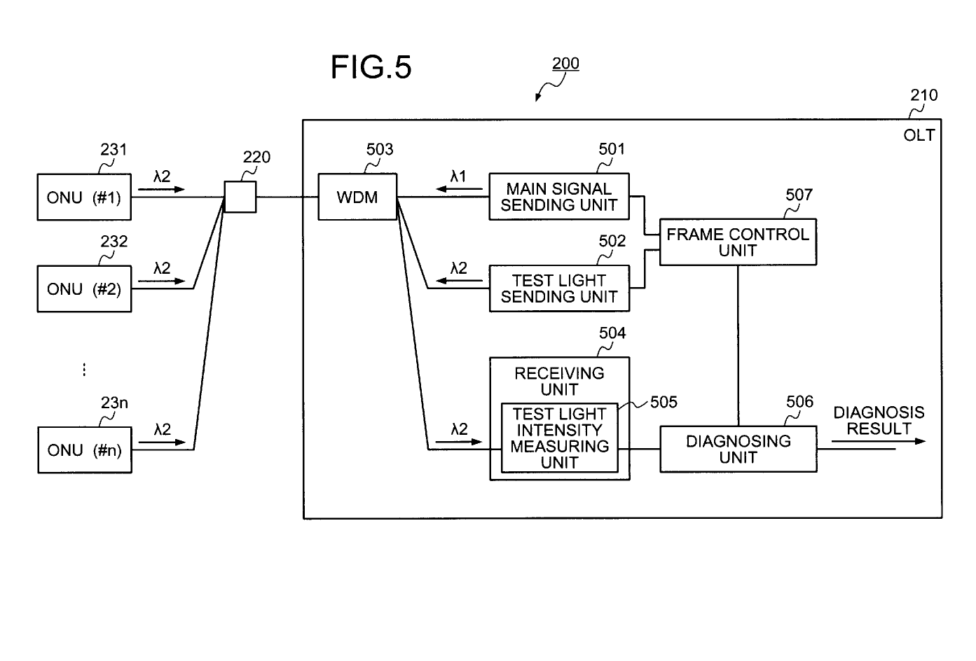

The transmitting apparatus 110 may include a receiving unit (see, e.g., FIG. 5) that receives the optical signals that are from the optical communication devices 131 to 13n and have been received by the light receiving unit 114 during a period different from the test period 141 set by the control unit 112.

The output unit 116 outputs information based on the intensity measured at elapsed times received from the measuring unit 115. For example, the output unit 116 outputs information indicating the intensity measured at elapsed times. Consequently, a user is able to identify a point of failure in the transmission lines between the transmitting apparatus 110 and the optical communication devices 131 to 13n, based on the intensity of the reflected light at each elapsed time after the sending of the test light.

For example, the user identifies an elapsed time when the intensity of the reflected light increases, based on the intensity measured at elapsed times. The user can determine that a distance acquired by multiplying a half of the identified elapsed time by the speed of light is the propagation distance from the transmitting apparatus 110 to the point of failure.

Alternatively, the user may operate the test light sending unit 113 to send the test light before operation of the transmission system 100 so as to measure and store the intensity of the reflected light received by the light receiving unit 114 at elapsed times after the sending of the test light from the test light sending unit 113. The user identifies an elapsed time when the intensity of the reflected light increases from the intensity before operation of the transmission system 100 by comparing the measurement result output from the output unit 116 during operation of the transmission system 100 and the measurement result stored before operation of the transmission system 100. The user can determine that the distance acquired by multiplying a half of the identified elapsed time by the speed of light is the propagation distance from the transmitting apparatus 110 to the point of failure.

The signal light sending unit 117 sends to the optical branching apparatus 120, the optical signals of the wavelength λ1 including the signals (#1 to #n) to the optical communication devices 131 to 13n. Since the optical signals sent by the signal light sending unit 117 have a wavelength different from the wavelength of the reflected light received by the light receiving unit 114, the period of sending the optical signals from the signal light sending unit 117 may overlap with the test period 141 set by the control unit 112.

The transmitting apparatus 110 depicted in FIGS. 1A and 1B can set the test period 141 in some frames so as not to allow the optical communication devices 131 to 13n to transmit the optical signals and can send the test light during the test period 141 to measure the reflected light. Since this enables the diagnosis of the transmission lines without disposing a mechanism separating the test light from the optical signals from the optical communication devices 131 to 13n, the transmission lines can be diagnosed while suppressing increase in apparatus scale. Therefore, for example, a configuration for diagnosing the transmission lines can be simplified and achieved at a lower cost.

Since the test period 141 is set in some frames, the optical signals from the optical communication devices 131 to 13n can be transmitted in a frame without the test period 141. Therefore, a reduction in transmission rate from the optical communication devices 131 to 13n to the transmitting apparatus 110 can be suppressed as compared to the case of defining the test period 141 in all the periodic frames.

When the wavelength of the test light is set to the wavelength λ2, which is different from the wavelength λ1 of the optical signals from the transmitting apparatus 110 to the optical communication devices 131 to 13n, the optical signals can be transmitted from the transmitting apparatus 110 to the optical communication devices 131 to 13n even during the test period 141. Therefore, the reduction in transmission rate from the transmitting apparatus 110 to the optical communication devices 131 to 13n can be suppressed.

When the wavelength of the test light is set to the same wavelength as the wavelength λ2 of the optical signals from the optical communication devices 131 to 13n to the transmitting apparatus 110, the test light can be received by a configuration for receiving the optical signals from the optical communication devices 131 to 13n to the transmitting apparatus 110. For example, if the wavelength multiplexing unit 111 or the light receiving unit 114 is disposed with a filter transmitting only a wavelength component of the wavelength λ2, the test light can be transmitted without expanding the transmission band of the filter so as to transmit the test light. As a result, the configuration can be simplified and achieved at a lower cost.

FIG. 1C is a diagram of a modification of the transmission system according to the embodiment (not during test). In FIG. 1C, the portions identical to those depicted in FIG. 1A are denoted by the same reference numerals used in FIG. 1A and will not be described. FIG. 1D is a diagram of a modification of the transmission system according to the embodiment (during test). In FIG. 1D, the portions identical to those depicted in FIG. 1B are denoted by the same reference numerals used in FIG. 1B and will not be described.

As depicted in FIGS. 1C and 1D, the transmitting apparatus 110 may further include a detecting unit 118. The detecting unit 118 detects failure in the transmission lines between the transmitting apparatus 110 and the optical communication devices 131 to 13n. Upon detecting failure, the detecting unit 118 may identify a transmission line having the failure among the transmission lines between the transmitting apparatus 110 and the optical communication devices 131 to 13n. The detecting unit 118 outputs a detection result to the control unit 112.

The control unit 112 sets the test period 141 in a frame based on the detection result output from the detecting unit 118 if the detecting unit 118 detects failure. Therefore, if failure occurs in the transmission lines between the transmitting apparatus 110 and the optical communication devices 131 to 13n, the point of failure can be diagnosed.

The control unit 112 may set the test period 141 in a frame before the detecting unit 118 detects failure. For example, the control unit 112 regularly sets the test period 141 in a frame before the detecting unit 118 detects failure. However, the interval between the test periods 141 set in the frames by the control unit 112 is set longer than a frame period. As a result, the test period 141 can be prevented from being set in all the frames.

The output unit 116 outputs information based on a result of comparison between a measurement result of intensity in the test period 141 set before the detecting unit 118 detects failure and a measurement result of intensity in the test period 141 set when the detecting unit 118 detects failure. For example, the output unit 116 outputs information based on the comparison result, enabling the identification of the point of failure in a transmission line.

For example, the transmitting apparatus 110 includes a calculating unit that identifies an elapsed time when the intensity of reflected light increases by a predetermined amount or more after failure is detected as compared to the intensity before the failure is detected, based on the comparison result and that multiplies a half of the identified elapsed time by the speed of light. The output unit 116 outputs the multiplication result from the calculating unit as information indicating the propagation distance from the transmitting apparatus 110 to the point of failure. This enables the user to easily identify the point of failure.

The control unit 112 may set the length of the test period 141 set before the detecting unit 118 detects failure, based on the longest propagation time among the propagation times of light between the optical communication devices 131 to 13n and the transmitting apparatus 110. For example, the control unit 112 sets the length of the test period 141 set before the detecting unit 118 detects failure to be twice the length of the longest propagation time. As a result, the length of the test period 141 can be set to a length allowing the test light to go and return through the transmission lines between the optical communication devices 131 to 13n and the transmitting apparatus 110. Therefore, the state of each point in the transmission lines can be measured with the test light.

The control unit 112 may set the length of the test period 141 set when the detecting unit 118 detects failure, based on a propagation time of light to the optical communication device according to a transmission line in which failure occurred, among the optical communication devices 131 to 13n. For example, the control unit 112 sets the length of the test period 141 set when the detecting unit 118 detects failure to be twice the length of the propagation time of light to the optical communication device corresponding to the transmission line in which the failure occurred. As a result, the length of the test period 141 can be set to a length allowing the test light to go and return through a transmission line in which failure occurs, among the optical communication devices 131 to 13n.

Therefore, a point of failure can be identified regardless of the point at which the failure occurs while the test period 141 is made shorter as compared to a case of causing the test light to go and return through all the transmission lines, for example. Since the test period 141 is made shorter, the optical signals can be transmitted from the optical communication devices 131 to 13n to the transmitting apparatus 110 for a longer period, thereby suppressing reductions in transmission rate.

A change in the state of the transmission lines caused by failure can be easily comprehended by performing a test on a regular basis before the detecting unit 118 detects failure and by making a comparison between a measurement result before detecting failure and a measurement result after detecting failure.

Description will be made of an example of a PON system to which the transmission system 100 depicted in FIGS. 1A and 1B is applied.

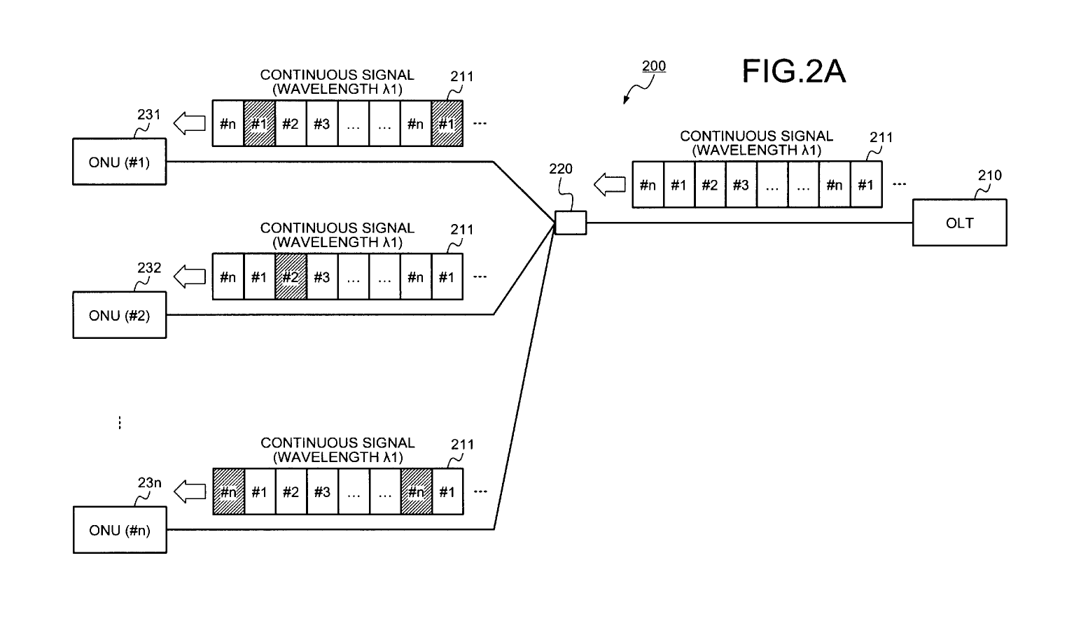

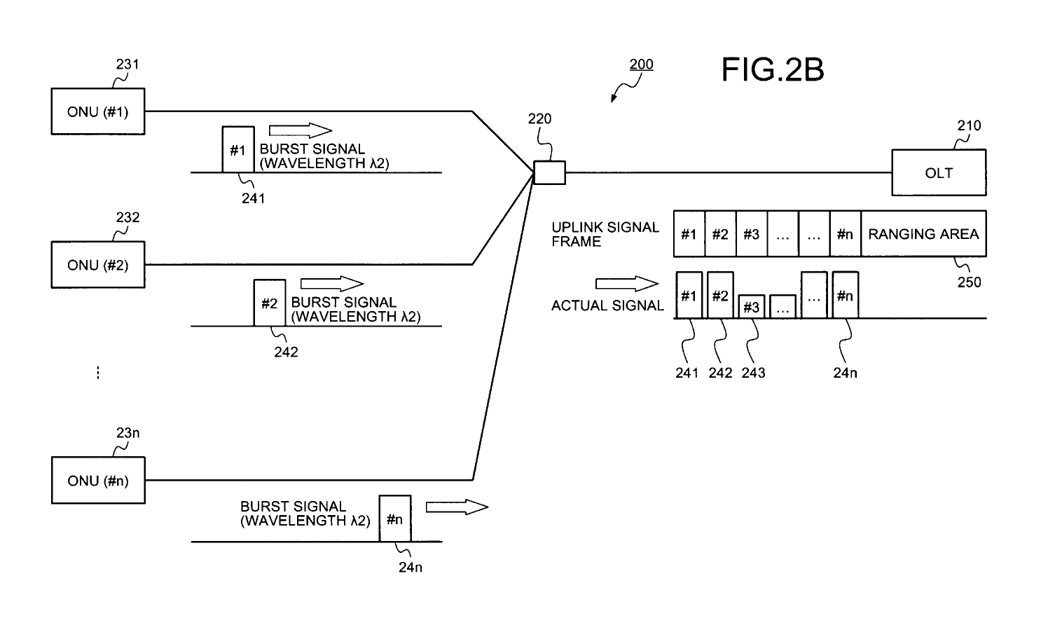

FIG. 2A is a diagram of an example of a PON system and downlink signals. A PON system 200 depicted in FIG. 2A is an example of the transmission system 100 depicted in FIGS. 1A and 1B. The PON system 200 includes an OLT 210, a star coupler 220, and n (n is a natural number greater than or equal to 2) ONUs 231 to 23n (#1 to #n). The OLT 210 is disposed on the side of a station of a telecommunications carrier (carrier), for example. The ONUs 231 to 23n are disposed on the side of end users (subscribers), for example.

The transmitting apparatus 110 depicted in FIGS. 1A to 1D can be implemented by the OLT 210, for example. The optical branching apparatus 120 depicted in FIGS. 1A to 1D can be implemented by the star coupler 220, for example. The optical communication devices 131 to 13n depicted in FIGS. 1A to 1D can be implemented by the ONUs 231 to 23n, for example.

The OLT 210 is connected one-to-n through the star coupler 220 to the ONUs 231 to 23n. The PON system 200 performs the transmission of downlink optical signals from the OLT 210 to the ONUs 231 to 23n and the transmission of uplink optical signals from the ONUs 231 to 23n to the OLT 210. FIG. 2A depicts the transmission of downlink optical signals from the OLT 210 to the ONUs 231 to 23n.

The OLT 210 sends a continuous signal 211 to the star coupler 220. The continuous signal 211 is a signal acquired by sequentially sending the signals (#n, #1, #2, #3, . . . , #n, #1) to the ONUs 231 to 23n. The wavelength of the continuous signal 211 is assumed to be λd (e.g., 1.57 [μm]).

The star coupler 220 branches the continuous signal 211 sent from the OLT 210 to send the branched continuous signals 211 respectively to the ONUs 231 to 23n. Each of the ONUs 231 to 23n extracts and receives a signal addressed to itself (shaded area) from the continuous signal 211 sent from the star coupler 220.

FIG. 2B is a diagram of an example of the PON system and uplink signals. In FIG. 2B, portions identical to those depicted in FIG. 2A are denoted by the same reference numerals used in FIG. 2A and will not be described. FIG. 2B depicts the transmission of uplink optical signals from the ONUs 231 to 23n to the OLT 210. Burst signals 241 to 24n depicted in FIG. 2B represent burst signals transmitted respectively from the ONUs 231 to 23n. The wavelength of the burst signals 241 to 24n is a wavelength λ2 (e.g., 1.27 [μm]) different from the wavelength λ1 of the continuous signal 211.

Since the ONUs 231 to 23n use the common wavelength λ2 for the uplink signals as described above, if the burst signals 241 to 24n are transmitted at the same timing, collision occurs at the star coupler 220. Therefore, the OLT 210 controls the transmission timings of the ONUs 231 to 23n so as to prevent collision of the burst signals 241 to 24n.

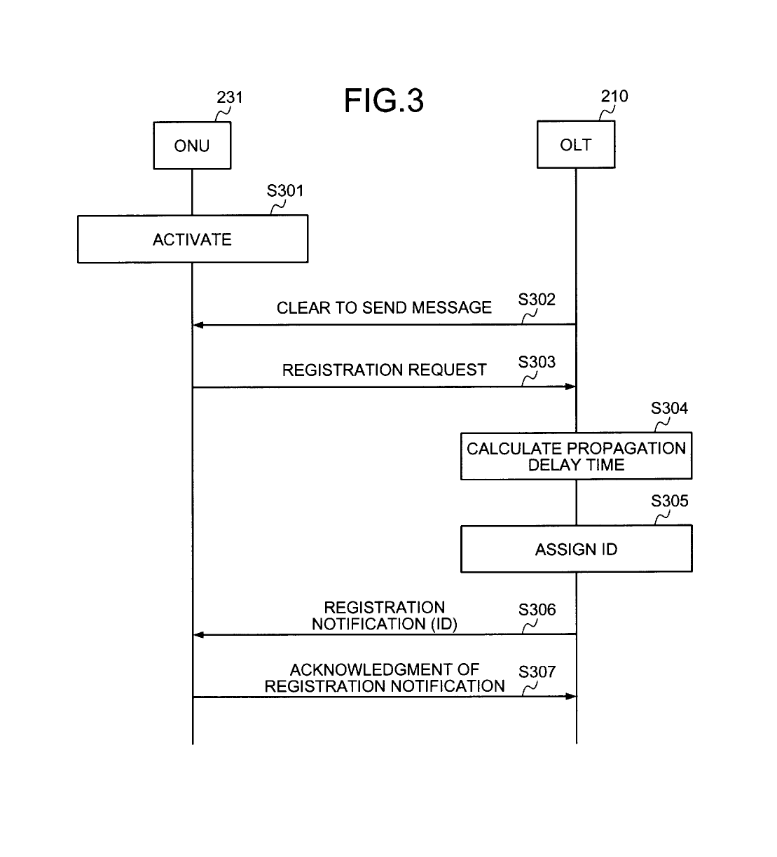

An uplink signal frame 250 is one cycle of frames (transmission periods) for uplink signals determined by the OLT 210. The uplink signal frame 250 includes, for example, periods (#1 to #n) for the ONUS 231 to 23n transmitting the burst signals 241 to 24n, and a ranging area. The ranging area of the uplink signal frame 250 is a period for ranging (see, e.g., FIG. 3). The ranging area may not be included in the uplink signal frames 250 of all the cycles and may be included in at least some of the uplink signal frames 250.

The OLT 210 determines the transmission timings of the ONUS 231 to 23n such that the reception timings in the OLT 210 are achieved as in the uplink signal frame 250 and gives the determined transmission timings to the respective ONUS 231 to 23n. For example, a downlink optical signal (e.g., the continuous signal 211 of FIG. 2B) can be used for giving the transmission timings.

In this example, the ONUS 231 to 23n have non-uniform propagation distances (e.g., fiber lengths) from the OLT 210. Therefore, the actual burst signals 241 to 24n received by the OLT 210 are at uneven levels as depicted in FIG. 2B, for example. The OLT 210 may determine the transmission timings of the ONUS 231 to 23n based on a difference of propagation distances to the ONUS 231 to 23n such that the reception timings in the OLT 210 are achieved as in the uplink signal frame 250.

FIG. 3 is a sequence diagram of an example of the ranging. Although the ranging between the ONU 231 and the OLT 210 will be described in this example, the same applies to the ranging between the ONUS 232 to 23n and the OLT 210. The transmission and reception of signals at the following steps are performed via the star coupler 220, for example.

As depicted in FIG. 3, first, when the ONU 231 is activated while the ONU 231 is not registered in the OLT 210 (step S301), the OLT 210 transmits a clear to send (CTS) message to the ONU 231 activated at step S301 (step S302). The ONU 231 transmits a registration request to the OLT 210 (step S303).

The OLT 210 calculates the propagation delay time between the OLT 210 and the ONU 231 based on the time consumed to receive the registration request at step S303 after transmission of the CTS message at step S302 (step S304). The propagation delay time is the time required for propagation of an optical signal between the OLT 210 and the ONU 231, for example. The propagation delay time can be calculated by dividing by two, the time consumed to receive the registration request after transmission of the CTS message.

The OLT 210 may calculate the propagation distance between the OLT 210 and the ONU 231 at step S304. The propagation distance between the OLT 210 and the ONU 231 can be calculated by multiplying the propagation delay time between the OLT 210 and the ONU 231 by the speed of light (e.g., 300,000 [km/s]).

The OLT 210 assigns an ID (e.g., logical link ID) to the ONU 231 (step S305). The ID assigned at step S305 is one of #1 to #n depicted in FIGS. 2A and 2B, for example.

The OLT 210 transmits a registration notification including the ID assigned at step S305 to the ONU 231 (step S306). The ONU 231 transmits an acknowledgment of the registration notification to the OLT 210 (step S307) to terminate a sequence of ranging.

With the steps described above, the OLT 210 can calculate the propagation delay time (or propagation distance) to the ONU 231 and can assign and send an ID to the ONU 231.

The OLT 210 calculates the transmission timings of the ONUS 231 to 23n causing no collision of the burst signals 241 to 24n, based on the propagation delay times of the ONUs 231 to 23n calculated at step S304 of the ranging for the ONUs 231 to 23n. The OLT 210 correlates the calculated transmission timings with the IDs assigned to the ONUs 231 to 23n at step S305 of the ranging and provides the transmission timings to the ONUs 231 to 23n through downlink signals, for example.

The ONUs 231 to 23n can each acquire the transmission timing thereof based on the ID given at step S306 of the ranging and the transmission timing for each ID provided by the OLT 210. The ONUs 231 to 23n can respectively transmit the burst signals 241 to 24n at the acquired transmission timings so as to avoid collisions in the uplink direction.

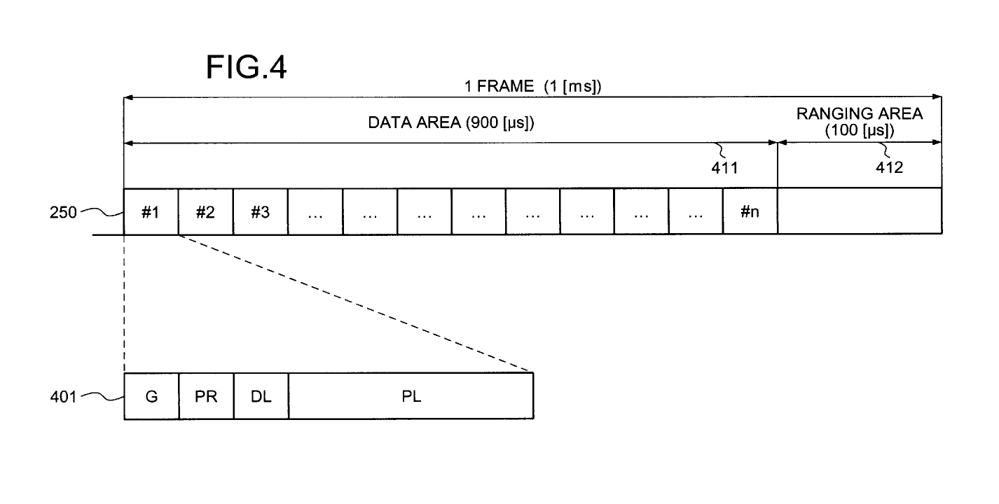

FIG. 4 is a diagram of an example of an uplink signal frame. The uplink signal frame 250 depicted in FIG. 4 is an example of the uplink signal frames 250 depicted in FIG. 2B. As depicted in FIG. 4, the uplink signal frame 250 is a signal frame of 1 [ms] per frame, for example. The uplink signal frame 250 includes a data area 411 and a ranging area 412, for example.

The data area 411 corresponds to areas (#1 to #n) of transmitting uplink signals from the ONUs 231 to 23n. The length of the data area 411 is 900 [μs], for example. The ranging area 412 is an area of performing the ranging depicted in FIG. 3. The length of the ranging area 412 is 100 [μs], for example. The uplink signals from the ONUs 231 to 23n are not transmitted in the ranging area 412.

A data area 401 represents an area for the ONU 231 (#1) transmitting the uplink signal at the top of the data area 411. The data area 401 includes, for example, a non-signal area G (guard time), a clock synchronization area PR (preamble), a byte synchronization area DL (delimiter), and an information area PL (payload). The data areas for the ONUs 232 to 23n (#2 to #n) transmitting the uplink signals are the same as the data area 401.

FIG. 5 is a diagram of an example of a configuration of the OLT. In FIG. 5, portions identical to those depicted in FIG. 2A or 2B are denoted by the same reference numerals used in FIGS. 2A and 2B and will not be described. The OLT 210 depicted in FIG. 5 is an example of the OLT 210 depicted in FIGS. 2A and 2B. As depicted in FIG. 5, the OLT 210 includes, for example, a main signal sending unit 501, a test light sending unit 502, a wavelength division multiplexer (WDM) 503, a receiving unit 504, a diagnosing unit 506, and a frame control unit 507.

The wavelength multiplexing unit 111 depicted in FIGS. 1A to 1D can be implemented by the WDM 503, for example. The control unit 112 depicted in FIGS. 1A to 1D can be implemented by the frame control unit 507, for example. The test light sending unit 113 depicted in FIGS. 1A to 1D can be implemented by the test light sending unit 502, for example.

The light receiving unit 114 and the measuring unit 115 depicted in FIGS. 1A to 1D can be implemented by the receiving unit 504, for example. The output unit 116 depicted in FIGS. 1A to 1D can be implemented by the diagnosing unit 506, for example. The signal light sending unit 117 depicted in FIGS. 1A to 1D can be implemented by the main signal sending unit 501, for example. The detecting unit 118 depicted in FIGS. 1C and 1D can be implemented by the frame control unit 507, for example.

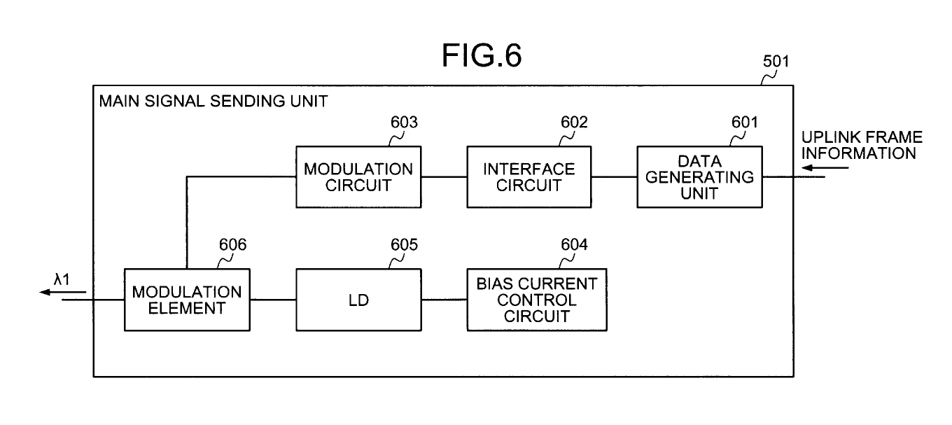

The main signal sending unit 501 sends a main downlink signal to the WDM 503. The main signal sent by the main signal sending unit 501 is an optical signal of the wavelength λ1 (e.g., 1.57 [μm]). The main signal sending unit 501 stores uplink frame information output from the frame control unit 507 into the main signal sent to the WDM 503. As a result, the respective transmission timings of uplink signals can be given to the ONUs 231 to 23n. The configuration of the main signal sending unit 501 will be described later (see, e.g., FIG. 6).

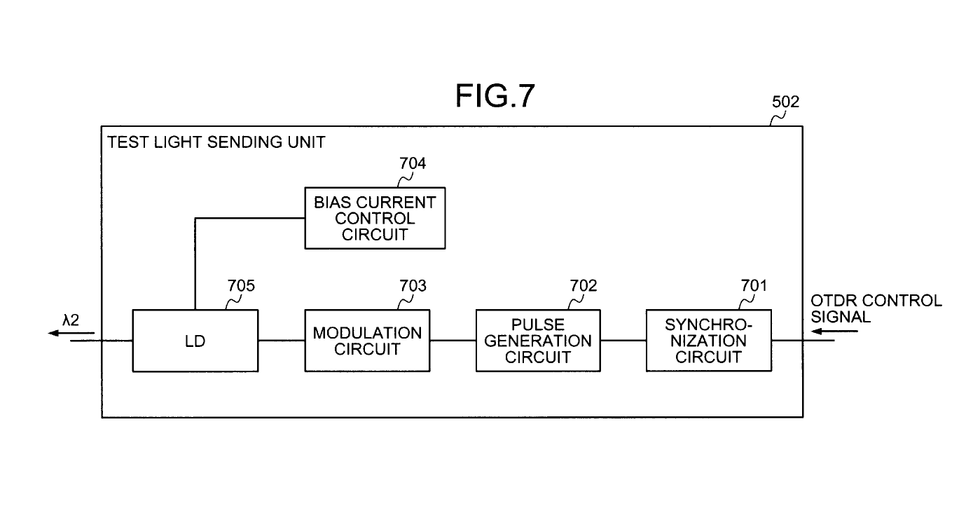

The test light sending unit 502 sends the test light to the WDM 503 at a timing specified by the frame control unit 507. The test light sent by the test light sending unit 502 is pulsed light of the wavelength λ2 (e.g., 1.27 [μm]), for example. The configuration of the test light sending unit 502 will be described later (see, e.g., FIG. 7).

The wavelength division multiplexing (WDM) 503 wavelength-multiplexes and sends to the star coupler 220, the main signal of the wavelength λ1 sent from the main signal sending unit 501 and the test light of the wavelength λ2 output from the test light sending unit 502.

Among the light sent from the star coupler 220, the WDM 503 sends the light of the wavelength λ2 to the receiving unit 504. As a result, the burst signals 241 to 24n from the ONUs 231 to 23n can be sent to a test light intensity measuring unit 505. The WDM 503 can send to the receiving unit 504, the test light reflected to the OLT 210 from among the test light sent from the test light sending unit 502 to the star coupler 220.

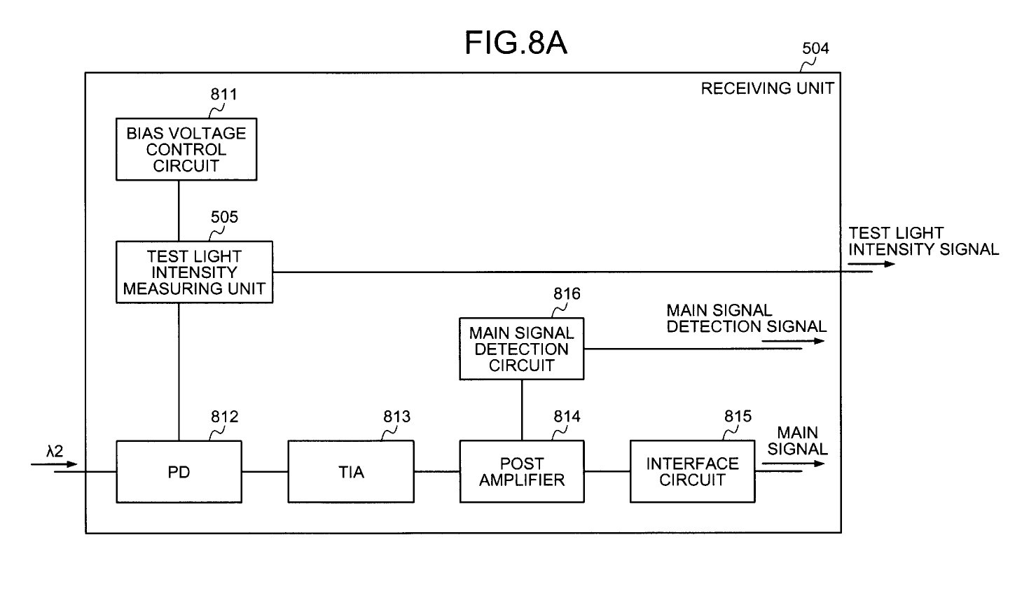

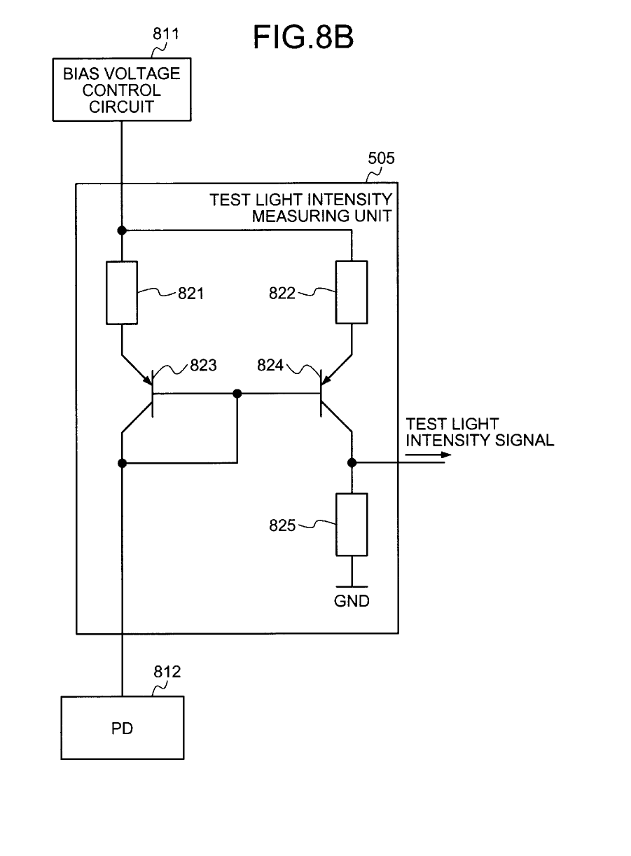

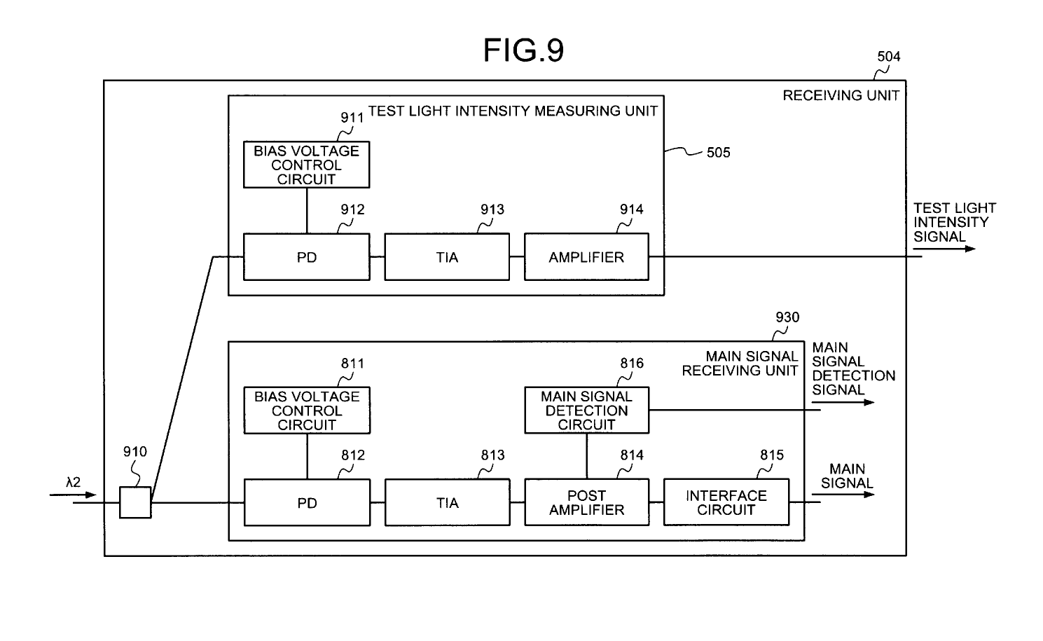

The receiving unit 504 receives the burst signals 241 to 24n sent from the WDM 503. The receiving unit 504 includes the test light intensity measuring unit 505. The test light intensity measuring unit 505 measures the intensity of the reflected test light sent from the WDM 503. The test light intensity measuring unit 505 outputs an intensity measurement result to the diagnosing unit 506. The configuration of the receiving unit 504 will be described later (see, e.g., FIGS. 8A to 9).

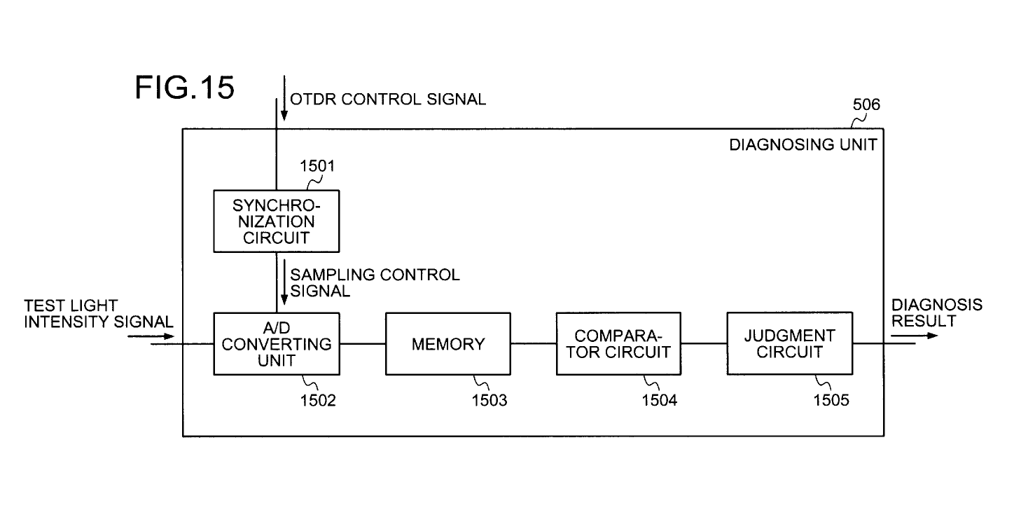

The diagnosing unit 506 diagnoses failure in the transmission lines of the PON system 200 based on the intensity measurement result output from the test light intensity measuring unit 505 and outputs a diagnosis result. For example, the frame control unit 507 may notify the diagnosing unit 506 of a period for conducting a test (OTDR) and the diagnosing unit 506 may perform diagnosis during the period. The configuration of the diagnosing unit 506 will be described later (see, e.g., FIG. 15).

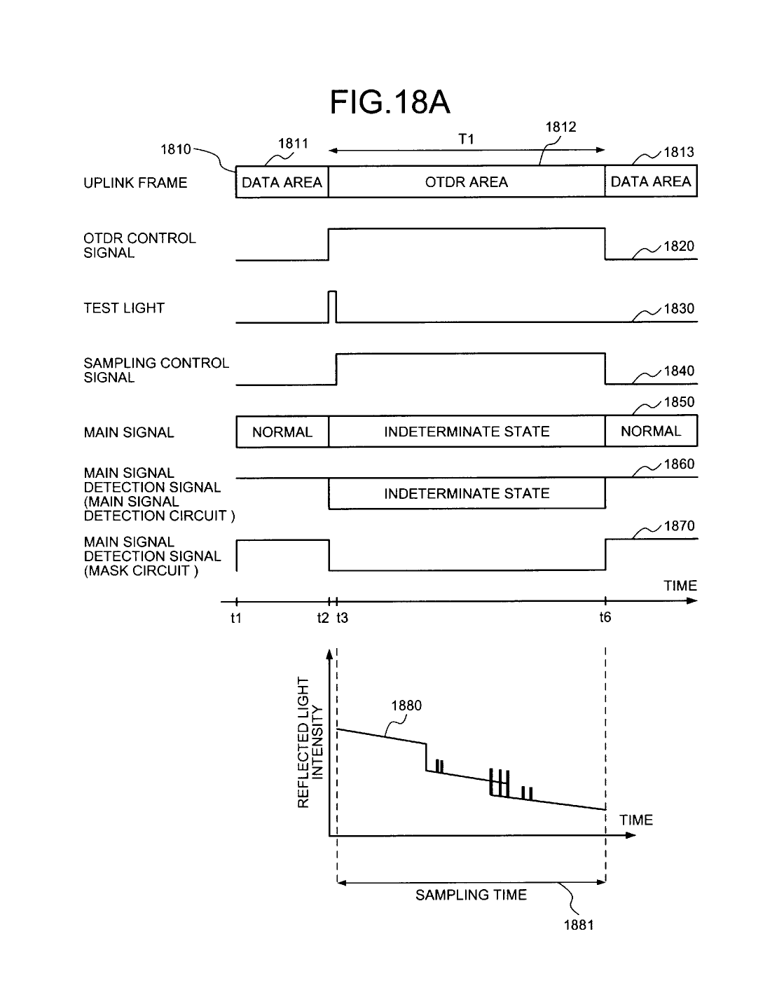

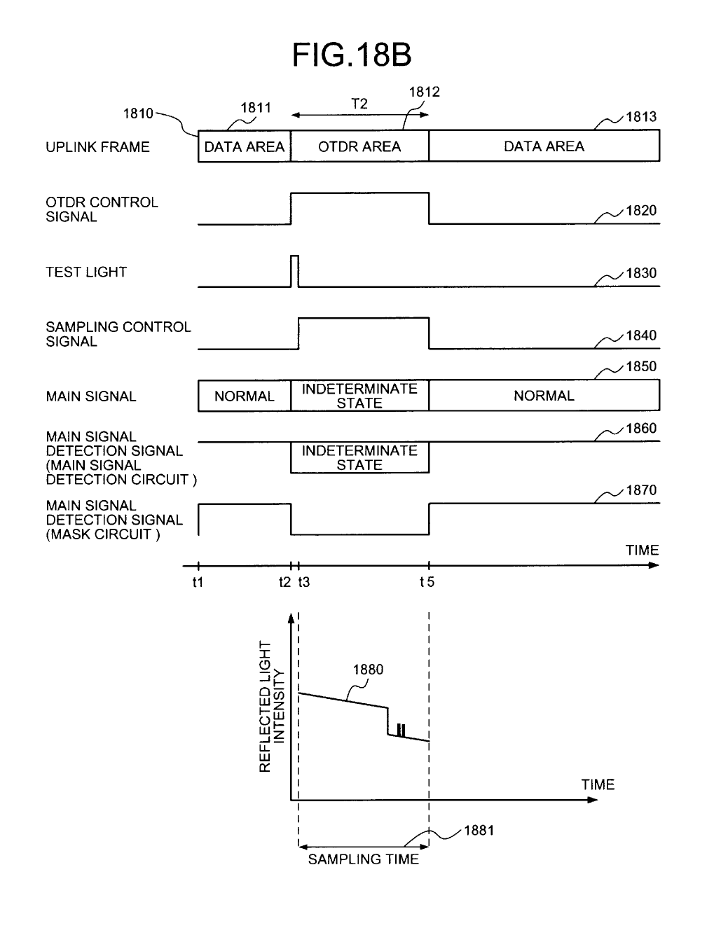

The frame control unit 507 controls uplink frames to control the transmission timings of optical signals from the ONUs 231 to 23n. The frame control unit 507 outputs to the main signal sending unit 501, the uplink frame information indicating the transmission timings of optical signals from the ONUs 231 to 23n. The frame control unit 507 sets an OTDR area (test period) for conducting the OTDR in some uplink frames. The frame control unit 507 outputs to the test light sending unit 502, an OTDR control signal (see, e.g., FIGS. 18A and 18B) indicating the set OTDR area. The frame control unit 507 may output the OTDR control signal also to the diagnosing unit 506.

FIG. 6 is a diagram of an example of a configuration of the main signal sending unit. The main signal sending unit 501 depicted in FIG. 6 is an example of the main signal sending unit 501 depicted in FIG. 5. As depicted in FIG. 6, the main signal sending unit 501 includes, for example, a data generating unit 601, an interface circuit 602, a modulation circuit 603, a bias current control circuit 604, an laser diode (LD) 605, and a modulation element 606.

The data generating unit 601 generates data (an electric signal) to be sent by a main signal. The data generating unit 601 stores into the generated data, the uplink frame information output from the frame control unit 507 (see, e.g., FIG. 5). The data generating unit 601 can be implemented as a function of an OLT unit, for example. The data generating unit 601 outputs the generated data to the interface circuit 602.

The interface circuit 602 receives the data output from the data generating unit 601. The interface circuit 602 outputs the received data to the modulation circuit 603. The modulation circuit 603 outputs to the modulation element 606 a drive signal based on the data output from the interface circuit 602.

The bias current control circuit 604 controls bias current supplied to the LD 605 to stabilize the optical output power of the LD 605. The LD 605 generates and outputs to the modulation element 606, light of the wavelength λ1. The light output by the LD 605 is continuous wave (CW) light, for example.

The modulation element 606 modulates the intensity of light output from the LD 605 with the drive signal output from the modulation circuit 603. The modulation element 606 sends the intensity-modulated light (wavelength λ1) as a main signal to the WDM 503 (see, e.g., FIG. 5). An electro-absorption (EA) modulator or a modulator using sodium niobate LiNbO3 (LN) can be used for the modulation element 606.

Although a configuration of an external modulation system modulating the light generated by the LD 605 with the modulation element 606 is described in this example, a configuration of a direct modulation system modulating light with the drive signal of the LD 605 is also available.

FIG. 7 is a diagram of an example of a configuration of the test light sending unit. The test light sending unit 502 depicted in FIG. 7 is an example of the test light sending unit 502 depicted in FIG. 5. As depicted in FIG. 7, the test light sending unit 502 includes, for example, a synchronization circuit 701, a pulse generation circuit 702, a modulation circuit 703, a bias current control circuit 704, and an LD 705.

The synchronization circuit 701 receives input of the OTDR control signal indicating the OTDR area (see, e.g., FIGS. 18A and 18B) from the frame control unit 507 (see, e.g., FIG. 5). The synchronization circuit 701 outputs a trigger signal to the pulse generation circuit 702, based on the input OTDR control signal at the start time of the OTDR area.

When the trigger signal is output from the synchronization circuit 701, the pulse generation circuit 702 generates and outputs to the modulation circuit 703, an electric signal pulse. The modulation circuit 703 outputs to the LD 705, a drive signal based on the pulse output from the pulse generation circuit 702.

The bias current control circuit 704 controls bias current supplied to the LD 705 to stabilize the optical output power of the LD 705. The LD 705 generates light of the wavelength λ2 at the intensity corresponding to the drive signal output from the modulation circuit 703 and sends the generated light as the test light to the WDM 503 (see, e.g., FIG. 5). As a result, the pulsed light of the wavelength λ2 can be sent as the test light at the start time of the OTDR area.

FIG. 8A is a diagram of an example of a configuration of the receiving unit. The receiving unit 504 depicted in FIG. 8A is an example of the receiving unit 504 depicted in FIG. 5. As depicted in FIG. 8A, the receiving unit 504 includes, for example, a bias voltage control circuit 811, a photo diode (PD) 812, a transimpedance amplifier (TIA) 813, a post amplifier 814, an interface circuit 815, and the test light intensity measuring unit 505. The receiving unit 504 may further include a main signal detection circuit 816.

The bias voltage control circuit 811 supplies bias voltage (reverse bias) to the PD 812. The bias voltage supplied by the bias voltage control circuit 811 varies according to the intensity of the light received by the PD 812.

The PD 812 receives the light of the wavelength λ2 sent from the WDM 503. The light received by the PD 812 includes the burst signals 241 to 24n from the ONUs 231 to 23n and the reflected test light of the test light sent from the test light sending unit 502. The PD 812 outputs a current signal indicating the intensity of the received light to the TIA 813. For example, an avalanche photo diode (APD) or a PIB photodiode can be used for the PD 812.

The test light intensity measuring unit 505 (see, e.g., FIG. 5) measures an amount of current of the bias voltage supplied from the bias voltage control circuit 811 to the PD 812 to measure the intensity of the test light received by the PD 812. The test light intensity measuring unit 505 outputs a test light intensity signal indicating a measurement result of the intensity to the diagnosing unit 506 (see, e.g., FIG. 5). The configuration of the test light intensity measuring unit 505 will be described later (see, e.g., FIG. 8B).

The TIA 813 converts the current signal output from the PD 812 into a voltage signal. The TIA 813 outputs the converted voltage signal to the post amplifier 814.

The post amplifier 814 amplifies the voltage signal output from the TIA 813 to a predetermined interface amplitude of the interface circuit 815. The post amplifier 814 outputs the amplified voltage signal to the interface circuit 815.

The interface circuit 815 receives the voltage signal output from the post amplifier 814. The interface circuit 815 outputs the received voltage signal as a main uplink signal transmitted from the ONUs 231 to 23n.

The main signal detection circuit 816 detects the presence or absence of a main signal from at least one of the ONUs 231 to 23n based on a voltage of the voltage signal amplified by the post amplifier 814, for example. The main signal detection circuit 816 outputs a main signal detection signal (see, e.g., FIGS. 18A and 18B) indicating a detection result.

FIG. 8B is a diagram of an example of a configuration of the test light intensity measuring unit depicted in FIG. 8A. The test light intensity measuring unit 505 depicted in FIG. 8B is an example of the test light intensity measuring unit 505 depicted in FIG. 8A. As depicted in FIG. 8B, the test light intensity measuring unit 505 depicted in FIG. 8A is a current mirror circuit including resistors 821, 822, transistors 823, 824, and a resistor 825, for example.

The resistor 821 is connected at one end to the bias voltage control circuit 811 and connected at the other end to an emitter of the transistor 823. The resistor 822 is connected at one end to the bias voltage control circuit 811 and connected at the other end to the emitter of the transistor 824.

The transistors 823 and 824 are bipolar transistors (BPTs), for example. The transistor 823 has the emitter connected to the resistor 821, a collector connected to the PD 812, and a base connected to a base of the transistor 824. The collector and the base of the transistor 823 are connected to each other. The transistor 824 has the emitter connected to the resistor 822, a collector connected to the resistor 825, and a base connected to the base of the transistor 823.

The resistor 825 is connected at one end to the collector of the transistor 824 and connected at the other end to ground (GND). Current flowing between the collector of the transistor 824 and the resistor 825 is output as the test light intensity signal to the diagnosing unit 506.

FIG. 9 is a diagram of a modification of the receiving unit. In FIG. 9, portions identical to those depicted in FIG. 8A are denoted by the same reference numerals used in FIG. 8A and will not be described. The receiving unit 504 depicted in FIG. 9 is a modification of the receiving unit 504 depicted in FIGS. 8A and 8B. As depicted in FIG. 9, the receiving unit 504 may include a coupler 910, the test light intensity measuring unit 505, and a main signal receiving unit 930.

The coupler 910 branches the light of the wavelength λ2 sent from the WDM 503 (see, e.g., FIG. 5). The coupler 910 outputs the branched light to the test light intensity measuring unit 505 and the main signal receiving unit 930.

The test light intensity measuring unit 505 includes a bias voltage control circuit 911, a PD 912, a TIA 913, and an amplifier 914. The bias voltage control circuit 911 supplies a bias voltage (reverse bias) to the PD 912.

The PD 912 receives the light output from the coupler 910 and outputs a current signal indicating the intensity of the received light to the TIA 913. For example, an APD or a PIB photodiode can be used for the PD 912.

The TIA 913 converts the current signal output from the PD 912 into a voltage signal. The TIA 913 outputs the converted voltage signal to the amplifier 914. The amplifier 914 amplifies the voltage signal output from the TIA 913. The amplifier 914 outputs the amplified voltage signal as a test light intensity signal to the diagnosing unit 506 (see, e.g., FIG. 5).

The main signal receiving unit 930 includes the bias voltage control circuit 811, the PD 812, the TIA 813, the post amplifier 814, the interface circuit 815, and the main signal detection circuit 816 depicted in FIG. 8A.

As described above, the test light intensity measuring unit 505 may be configured separately from the main signal receiving unit 930 by branching the input light with the coupler 910. As a result, for example, the sensitivity of the PD 912 of the test light intensity measuring unit 505 can be made higher than the PD 812 of the main signal receiving unit 930 so as to more accurately measure the intensity of reflected light of weak test light. For example, if an APD is used for the PD 912, an M value of the APD can be adjusted to make the sensitivity of the PD 912 higher.

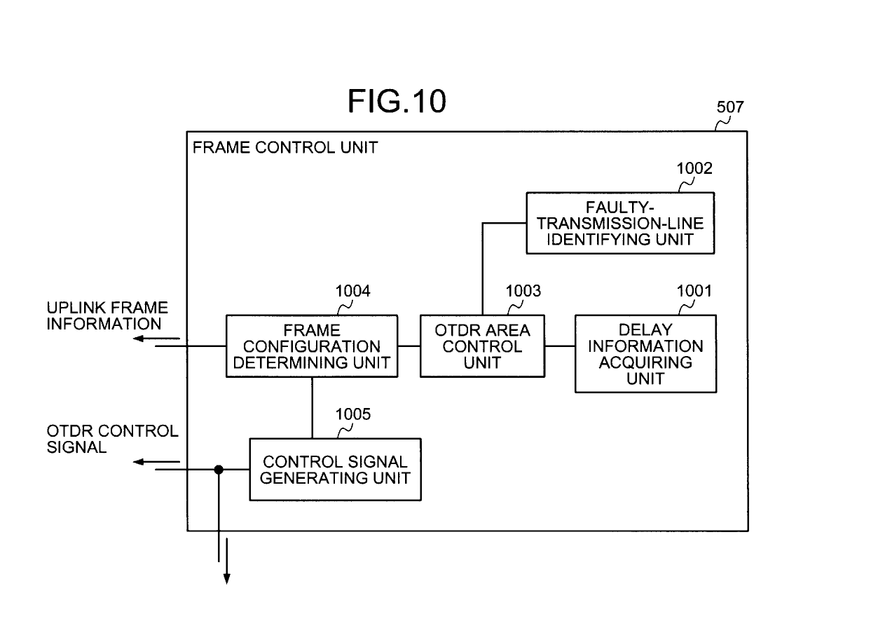

FIG. 10 is a diagram of an example of a configuration of the frame control unit. The frame control unit 507 depicted in FIG. 10 is an example of the test light intensity measuring unit 505 depicted in FIG. 5. As depicted in FIG. 10, the frame control unit 507 includes, for example, a delay information acquiring unit 1001, a faulty-transmission-line identifying unit 1002, an OTDR area control unit 1003, a frame configuration determining unit 1004, and a control signal generating unit 1005.

The delay information acquiring unit 1001 acquires delay information indicating a propagation delay time of a transmission line to the OLT 210 for each of the ONUs 231 to 23n. The delay information can be acquired by the ranging depicted in FIG. 3, for example. Alternatively, the delay information may be stored in a memory of the OLT 210 in advance and the delay information acquiring unit 1001 may acquire the delay information stored in the memory. The delay information acquiring unit 1001 outputs the acquired delay information to the OTDR area control unit 1003.

The faulty-transmission-line identifying unit 1002 detects failure (e.g., line disconnection) in the transmission lines between the ONUs 231 to 23n and the OLT 210 and identifies the transmission line in which the failure occurs. The faulty-transmission-line identifying unit 1002 outputs faulty transmission line information indicating the identified transmission line to the OTDR area control unit 1003. The faulty-transmission-line information output from the faulty-transmission-line identifying unit 1002 may also be output to a user of the OLT 210, for example.

The faulty-transmission-line identifying unit 1002 can be implemented by an OAM function or a main signal detection function using optical input power included in the OLT 210 as a function of the PON system. For example, if the faulty-transmission-line identifying unit 1002 is implemented by using the OAM function, each of the ONUs 231 to 23n stores various types of information of the ONU into an information area (e.g., PL depicted in FIG. 4) of an uplink signal. The OLT 210 acquires the information stored in the uplink signals to monitor the state of the ONUs 231 to 23n. As a result, if a failure such as line disconnection occurs, the ONU corresponding to the transmission line having the failure can be identified among the ONUs 231 to 23n.

If the faulty-transmission-line identifying unit 1002 is implemented by using the main signal detection function using optical input power, failure can be detected and the transmission line in which the failure occurred can be identified based on the main signal detection signal output from the main signal detection circuit 816 depicted in FIG. 8A, for example.

The OTDR area control unit 1003 controls the presence and length of an OTDR area included in an uplink frame determined by the frame configuration determining unit 1004. For example, the OTDR area control unit 1003 determines the execution timing of an OTDR test.

For example, the OTDR area control unit 1003 determines whether a failure occurs based on the faulty-transmission-line information output from the faulty-transmission-line identifying unit 1002. If no failure occurs (at the normal time), the OTDR area control unit 1003 determines the execution timing of the OTDR test as a regular timing. For example, the regular timing is a timing of once for every N uplink frames (N is a natural number greater than or equal to 2) in periodic uplink frames, for example.

If a failure occurs, the OTDR area control unit 1003 determines the execution timing of the OTDR test as the next uplink frame, for example. The OTDR area control unit 1003 gives the determined execution timing of the OTDR test to the frame configuration determining unit 1004.

The OTDR area control unit 1003 determines the length of the OTDR area for the OTDR test of the determined execution timing. The OTDR area control unit 1003 gives the length of the OTDR area to the frame configuration determining unit 1004 along with the determined execution timing of the OTDR test.

For example, the OTDR area control unit 1003 refers to the delay information output from the delay information acquiring unit 1001 for the regular OTDR area when no failure occurs (at the normal time). The OTDR area control unit 1003 determines the length of the OTDR area based on the longest propagation delay time among the propagation delay times between the ONUs 231 to 23n and the OLT 210.

For example, the OTDR area control unit 1003 determines the length of the OTDR area at the normal time to be twice the length of the longest propagation delay time. As a result, a time required for the test light sent by the OLT 210 to go through all the transmission lines of the ONUs 231 to 23n and return to the OLT 210 can be ensured as the OTDR area.

For the OTDR area at the time of failure, the OTDR area control unit 1003 acquires among the propagation delay times indicated by delay information, a propagation delay time corresponding to a transmission line in which the failure occurred. The OTDR area control unit 1003 determines the length of the OTDR area at the time of failure to be twice the length of the acquired propagation delay time. As a result, the time required for the test light sent by the OLT 210 to go through the transmission line in which the failure occurred among the transmission lines and return to the OLT 210 can be ensured as the OTDR area.

The frame configuration determining unit 1004 determines uplink frame configuration. For example, the frame configuration determining unit 1004 determines the data area 411 depicted in FIG. 4 for each uplink frame. The frame configuration determining unit 1004 determines the uplink frame configuration such that the ranging area 412 depicted in FIG. 4 is included in the case of the uplink frame corresponding to the period of the ranging.

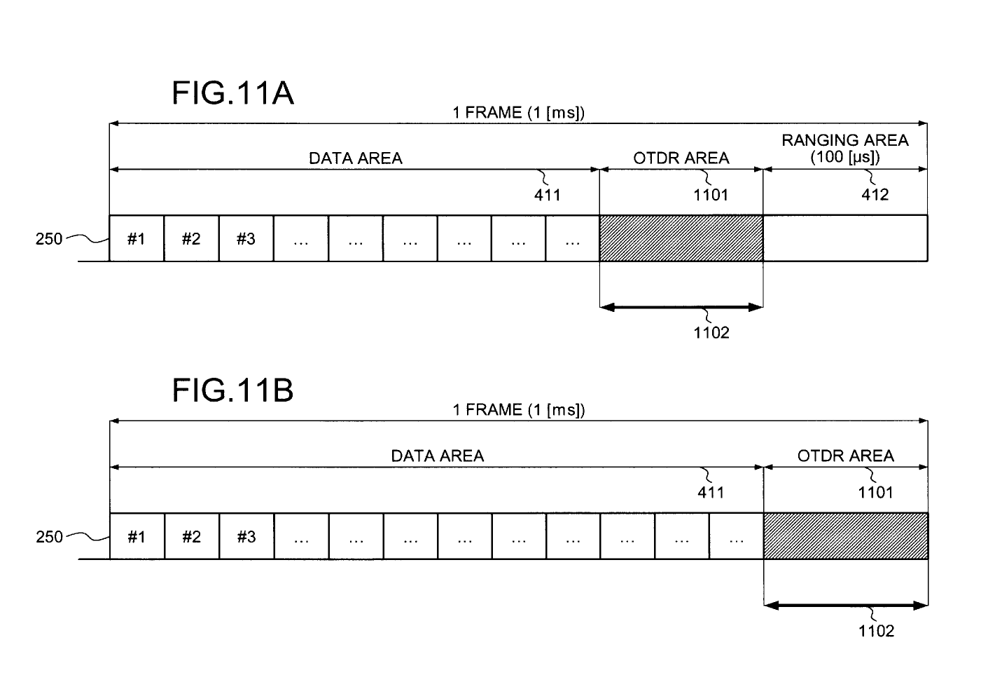

The frame configuration determining unit 1004 determines the uplink frame configuration such that the OTDR area (see, e.g., FIGS. 11A and 11B) is included in the case of the uplink frame corresponding to the execution timing given from the OTDR area control unit 1003. If the length of the OTDR area is given from the OTDR area control unit 1003 along with the execution timing, the frame configuration determining unit 1004 determines the uplink frame configuration such that the length of the OTDR area is set to the given length.

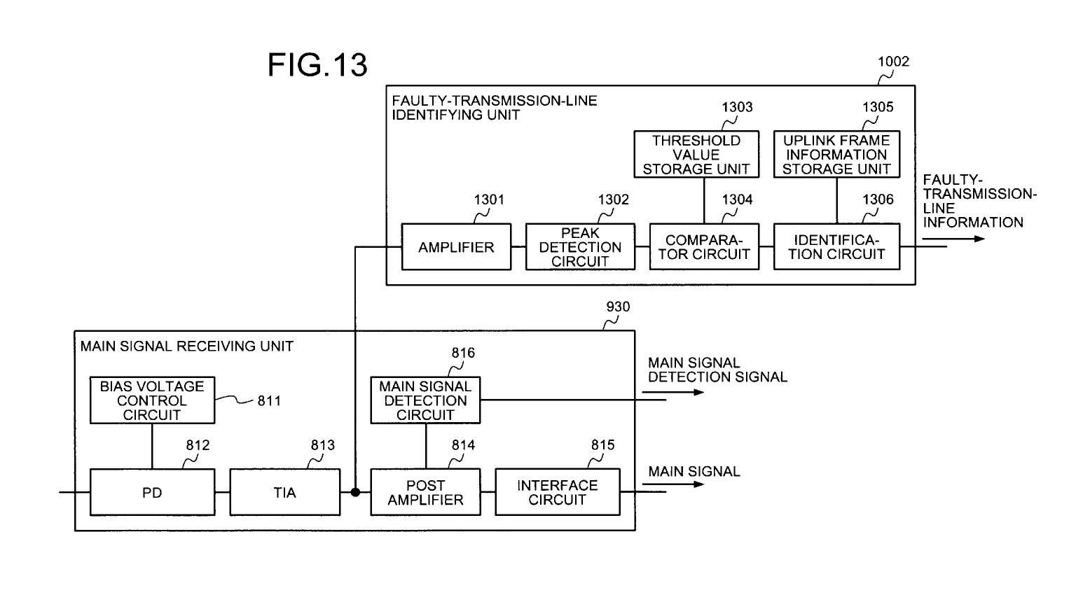

The frame configuration determining unit 1004 outputs uplink frame information indicating a determination result of the uplink frame configuration (see, e.g., FIGS. 4, 11A, and 11B) to the main signal sending unit 501. The frame configuration determining unit 1004 may store the uplink frame information into a memory of the OLT 210 (e.g., an uplink frame information storage unit 1305 depicted in FIG. 13). The frame configuration determining unit 1004 gives a period of the OTDR area to the control signal generating unit 1005, based on the determination result of the uplink frame configuration.

The control signal generating unit 1005 outputs to the test light sending unit 502 and the diagnosing unit 506, an OTDR control signal indicating the period of the OTDR area specified by the frame configuration determining unit 1004. The frame control unit 507 depicted in FIG. 10 can be implemented by a digital circuit such as a field programmable gate array (FPGA) and a digital signal processor (DSP), for example.

FIG. 11A is a diagram of a first configuration example of an uplink frame including an OTDR area. In FIG. 11A, portions identical to those depicted in FIG. 4 are denoted by the same reference numerals used in FIG. 4 and will not be described. In FIG. 11A, description will be made of a case in which the execution timing of the OTDR test given from the OTDR area control unit 1003 to the frame configuration determining unit 1004 is the timing of the uplink signal frame 250 including the ranging area 412.

In this case, as depicted in FIG. 11A, the frame configuration determining unit 1004 stores the data area 411, an OTDR area 1101, and the ranging area 412 into the uplink signal frame 250. A range length 1102 of the OTDR area 1101 is set to the length of the OTDR area 1101 given from the OTDR area control unit 1003 to the frame configuration determining unit 1004.

FIG. 11B is a diagram of a second configuration example of an uplink frame including an OTDR area. In FIG. 11B, portions identical to those depicted in FIG. 11A are denoted by the same reference numerals used in FIG. 11A and will not be described. In FIG. 11B, description will be made of a case in which the execution timing of the OTDR test given from the OTDR area control unit 1003 to the frame configuration determining unit 1004 is the timing of the uplink signal frame 250 without the ranging area 412.

In this case, as depicted in FIG. 11B, the frame configuration determining unit 1004 stores the data area 411 and the OTDR area into the uplink signal frame 250. The range length 1102 of the OTDR area 1101 is set to the length of the OTDR area 1101 given from the OTDR area control unit 1003 to the frame configuration determining unit 1004.

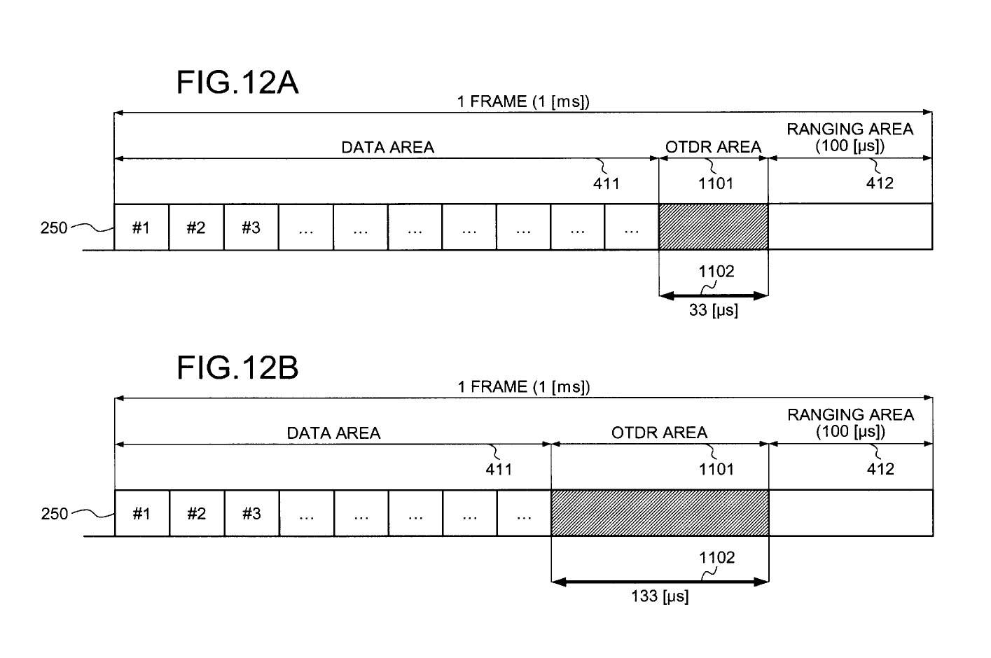

FIG. 12A is a diagram of a configuration example of an uplink frame including a relatively short OTDR area. The uplink signal frame 250 depicted in FIG. 12A is an example of the uplink signal frame 250 including the relatively short OTDR area 1101. For example, if a failure occurs in the ONU 231, the frame control unit 507 determines the length of the OTDR area 1101 based on the propagation delay time between the ONU 231 and the OLT 210. For example, it is assumed that the propagation distance between the ONU 231 and the OLT 210 is 5 [km].

In this case, the round-trip propagation distance between the ONU 231 and the OLT 210 is 5×2=10 [km] and, when it is assumed that the speed of light is about 300,000 [km/s], the round-trip propagation delay time is 10 [km]/300,000 [km/s]≈33 [μs]. Therefore, the frame control unit 507 sets the area length 1102 of the OTDR area 1101 to 33 [μs].

FIG. 12B is a diagram of a configuration example of an uplink frame including a relatively long OTDR area. The uplink signal frame 250 depicted in FIG. 12B is an example of the uplink signal frame 250 having the area length 1102 determined based on a relatively long propagation distance. For example, if no failure occurs in the ONUS 231 to 23n, the frame control unit 507 determines the length of the OTDR area 1101 based on the longest propagation delay time among the propagation delay times between the ONUS 231 to 23n and the OLT 210. For example, it is assumed that the longest propagation distance among the propagation distances between the ONUS 231 to 23n and the OLT 210 is a propagation distance of 20 [km] between the ONU 232 and the OLT 210.

In this case, a round-trip propagation distance between the ONU 232 and the OLT 210 is 20×2=40 [km] and, when it is assumed that the speed of light is about 300,000 [km/s], the round-trip propagation delay time is 40 [km]/300,000 [km/s]≈133 [μs]. Therefore, the frame control unit 507 sets the area length 1102 of the OTDR area 1101 to 133 [μs].

As described above, if the OTDR test is executed, the uplink frame information indicating the uplink signal frame 250 including the OTDR area 1101 is transmitted to the ONUs 231 to 23n. The ONUs 231 to 23n transmit no uplink signal in the OTDR area 1101 indicated by the uplink frame information. On the other hand, the OLT 210 sends the test light in the OTDR area 1101 to diagnose the transmission lines based on the reflected light of the sent test light. The OLT 210 continues to send downlink signals even in the OTDR area 1101.

FIG. 13 is a diagram of an example of a configuration of the faulty-transmission-line identifying unit. The faulty-transmission-line identifying unit 1002 depicted in FIG. 13 is an example of the faulty-transmission-line identifying unit 1002 depicted in FIG. 10. As depicted in FIG. 13, the faulty-transmission-line identifying unit 1002 includes, for example, an amplifier 1301, a peak detection circuit 1302, a threshold value storage unit 1303, a comparator circuit 1304, an uplink frame information storage unit 1305, and an identification circuit 1306.

The amplifier 1301 receives input of a voltage signal that is output from the TIA 813 of the main signal receiving unit 930 to the post amplifier 814. The amplifier 1301 amplifies the input voltage signal and outputs the amplified voltage signal to the peak detection circuit 1302.

The peak detection circuit 1302 detects a peak value of the voltage signal output from the amplifier 1301. The peak detection circuit 1302 outputs the detected peak value to the comparator circuit 1304. A predetermined threshold value is stored in the threshold value storage unit 1303.

The comparator circuit 1304 compares the peak value output from the peak detection circuit 1302 with the threshold value stored in the threshold value storage unit 1303. If the peak value falls below the threshold value, the comparator circuit 1304 outputs a failure detection signal indicating the detection of failure to the identification circuit 1306.

In the uplink frame information storage unit 1305, for example, the uplink frame information is stored that is output from the frame configuration determining unit 1004 of the frame control unit 507.

If the comparator circuit 1304 outputs the failure detection signal, the identification circuit 1306 identifies the transmission line having the failure based on the uplink frame information stored in the uplink frame information storage unit 1305. For example, the identification circuit 1306 identifies an ID (one of #1 to #n) corresponding to the time of output of the failure detection signal in the data area 411 of the uplink signal frame 250.

This enables the identification of the transmission line where the failure occurs among the transmission lines to the ONUs 231 to 23n. The identification circuit 1306 outputs faulty transmission line information indicating the identified transmission line to the OTDR area control unit 1003 (see, e.g., FIG. 10). The faulty-transmission-line information is an ID indicating one of #1 to #n, for example.

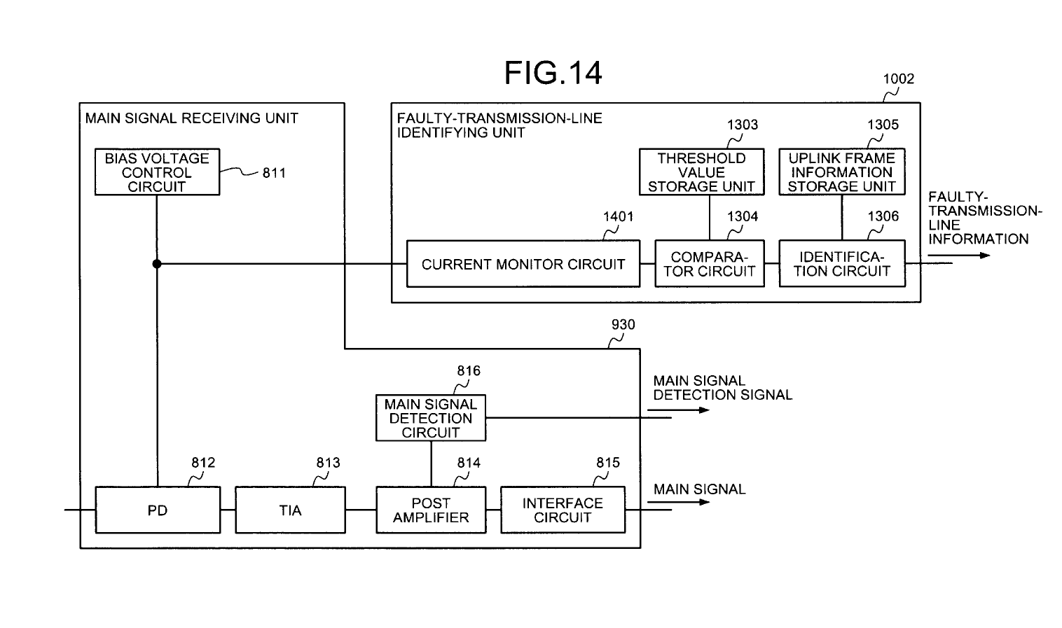

FIG. 14 is a diagram of a modification of the faulty-transmission-line identifying unit. In FIG. 14, portions identical to those depicted in FIG. 13 are denoted by the same reference numerals used in FIG. 13 and will not be described. As depicted in FIG. 14, the faulty-transmission-line identifying unit 1002 may include a current monitor circuit 1401, the threshold value storage unit 1303, the comparator circuit 1304, the uplink frame information storage unit 1305, and the identification circuit 1306.

The current monitor circuit 1401 measures a current value of the bias voltage supplied from the bias voltage control circuit 811 of the main signal receiving unit 930 to the PD 812. The current monitor circuit 1401 outputs the measured current value to the comparator circuit 1304. The comparator circuit 1304 compares the current value output from the current monitor circuit 1401 and the threshold value stored in the threshold value storage unit 1303. If the current value falls below the threshold value, the comparator circuit 1304 outputs a failure detection signal indicating the detection of failure to the identification circuit 1306.

As depicted in FIGS. 13 and 14, the faulty-transmission-line identifying unit 1002 can be implemented by an input optical power monitoring function.

FIG. 15 is a diagram of an example of a configuration of the diagnosing unit. The diagnosing unit 506 depicted in FIG. 15 is an example of the diagnosing unit 506 depicted in FIG. 5. As depicted in FIG. 15, the diagnosing unit 506 includes, for example, a synchronization circuit 1501, an A/D converting unit 1502, a memory 1503, a comparator circuit 1504, and a judgment circuit 1505.

The synchronization circuit 1501 outputs to the A/D converting unit 1502 a sampling control signal indicating a sampling period of the A/D converting unit 1502 based on the OTDR control signal output from the frame control unit 507. For example, the sampling period of the A/D converting unit 1502 is a period acquired by subtracting a test light sending period at the top of the OTDR area from the OTDR area indicated by the OTDR control signal (see, e.g., FIGS. 18A and 18B).

The A/D converting unit 1502 converts the test light intensity signal output from the test light intensity measuring unit 505 into a digital signal by sampling for a sampling period indicated by the sampling control signal from the synchronization circuit 1501. The A/D conversion circuit 1502 correlates the intensity converted into the digital signal with a current time, for example, and outputs the intensity to the memory 1503.

The memory 1503 stores both the intensity at each time output from the A/D conversion circuit 1502 in the sampling period of the OTDR at the normal time and the intensity at each time output from the A/D conversion circuit 1502 in the sampling period of the OTDR at the time of failure.

For example, the diagnosing unit 506 includes a memory control circuit controlling the memory 1503 and the memory control circuit acquires the failure detection signal from the faulty-transmission-line identifying unit 1002. The memory control circuit controls the memory 1503 based on the acquired failure detection signal such that the storage area of the memory 1503 storing the intensity at each time output from the A/D conversion circuit 1502 is differentiated between the normal time when no failure occurs and the time of failure. As a result, an intensity measurement result of the reflected light of the test light at the normal time and an intensity measurement result of the reflected light of the test light at the time of failure can be stored in the memory 1503.

The comparator circuit 1504 acquires the intensity measurement result of the reflected light of the test light at the normal time and the intensity measurement result of the reflected light of the test light at the time of failure from the memory 1503. The comparator circuit 1504 compares the acquired intensity measurement results and outputs a comparison result to the judgment circuit 1505. For example, the comparator circuit 1504 calculates a difference between the intensity measurement result at the normal time and the intensity measurement result at the time of failure for each period of time elapsing since the start time of the OTDR area. The comparator circuit 1504 outputs to the judgment circuit 1505, the calculated difference that the elapsed time exceeds a threshold value by.

The judgment circuit 1505 judges a point of failure in the transmission channel having the failure based on the comparison result output from the comparator circuit 1504. For example, the elapsed time output from the judgment circuit 1505 indicates a round-trip propagation delay time of the test light between the point of failure and the OLT 210.

Therefore, the judgment circuit 1505 can judge a propagation distance between the point of failure and the OLT 210 by multiplying a half of the elapsed time output from the judgment circuit 1505 by the speed of light. The judgment circuit 1505 outputs a calculation result as a diagnosis result. The diagnosis result output from the judgment circuit 1505 is output to the user of the OLT 210, for example.

This enables the identification of a transmission line and a point thereof where the failure occurs, according to the faulty-transmission-line information output from the faulty-transmission-line identifying unit 1002 and the diagnosis result output from the judgment circuit 1505.

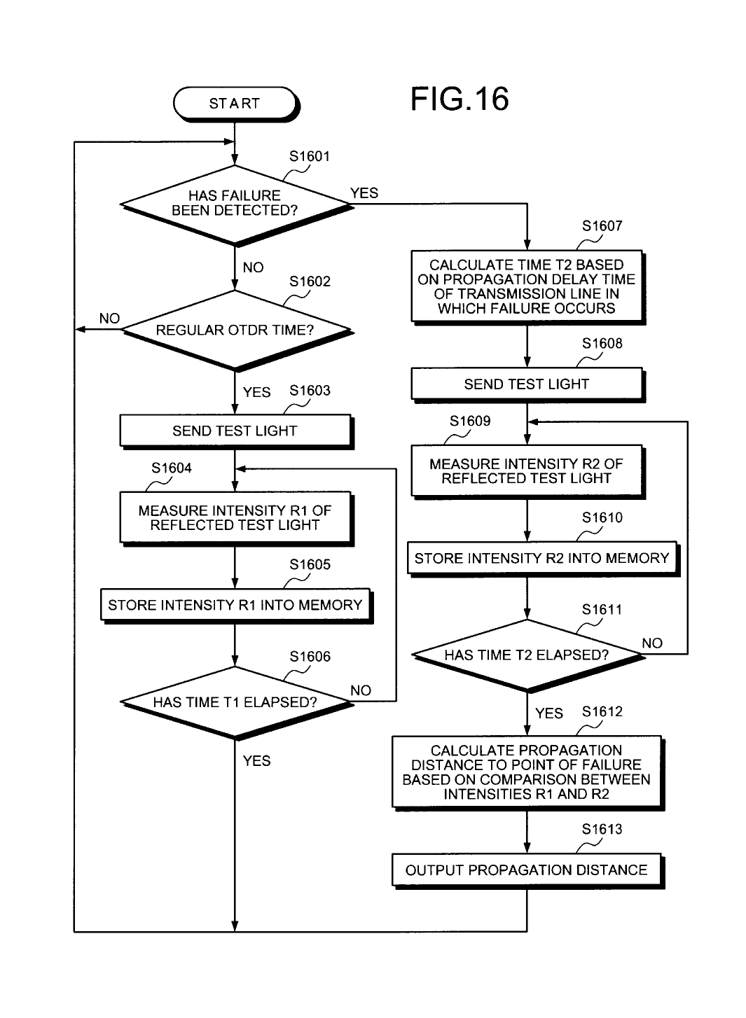

FIG. 16 is a flowchart of an example of the operation of the OLT. The OLT 210 performs the following steps, for example. First, the OLT 210 determines whether failure is detected in any transmission line to the ONUs 231 to 23n (step S1601). If failure is not detected (step S1601: NO), the OLT 210 determines whether it is the regular OTDR time (step S1602).

If it is not the regular OTDR time at step S1602 (step S1602: NO), the OLT 210 returns to step S1601. If it is the regular OTDR time (step S1602: YES), the OLT 210 sends the test light (step S1603). The OLT 210 measures intensity R1 of the reflected light of the test light sent at step S1603 (step S1604).

The OLT 210 stores into the memory 1503, the intensity R1 measured at step S1604 as an intensity measurement result at the normal time (step S1605). The OLT 210 determines whether a time T1 has elapsed since sending of the test light at step S1603 (step S1606). The time T1 is twice the longest propagation delay time (round-trip propagation delay time) among the propagation delay times between the ONUs 231 to 23n and the OLT 210, for example.

If the time T1 has not elapsed at step S1606 (step S1606: NO), the OLT 210 returns to step S1604. If the time T1 has elapsed (step S1606: YES), the OLT 210 returns to step S1601.

If failure is detected at step S1601 (step S1601: YES), the OLT 210 calculates a time T2 based on the propagation delay time of the transmission line in which the failure occurs (step S1607). The time T2 is twice the propagation delay time (round-trip propagation delay time) of the transmission line in which the failure occurs, for example. The OLT 210 sends the test light (step S1608). The OLT 210 measures intensity R2 of the reflected light of the test light sent at step S1608 (step S1609).

The OLT 210 stores the intensity R2 measured at step S1609 as an intensity measurement result at the time of failure into the memory 1503 (step S1610). The OLT 210 determines whether the time T2 calculated at step S1607 has elapsed since sending of the test light at step S1608 (step S1611). If the time T2 has not elapsed (step S1611: NO), the OLT 210 returns to step S1609.

If the time T2 has elapsed at step S1611 (step S1611: YES), the OLT 210 calculates a propagation distance to the point of failure based on comparison between the intensities R1 and R2 stored at steps S1605 and S1610 (step S1612). The OLT 210 outputs the propagation distance calculated at step S1612 as a diagnosis result (step S1613) and returns to step S1601.

With the steps described above, the propagation distance from the OLT 210 to the point of failure can be identified based on a difference between the intensity measurement result from the OTDR at the normal time and the intensity measurement result from the OTDR at the time of failure.

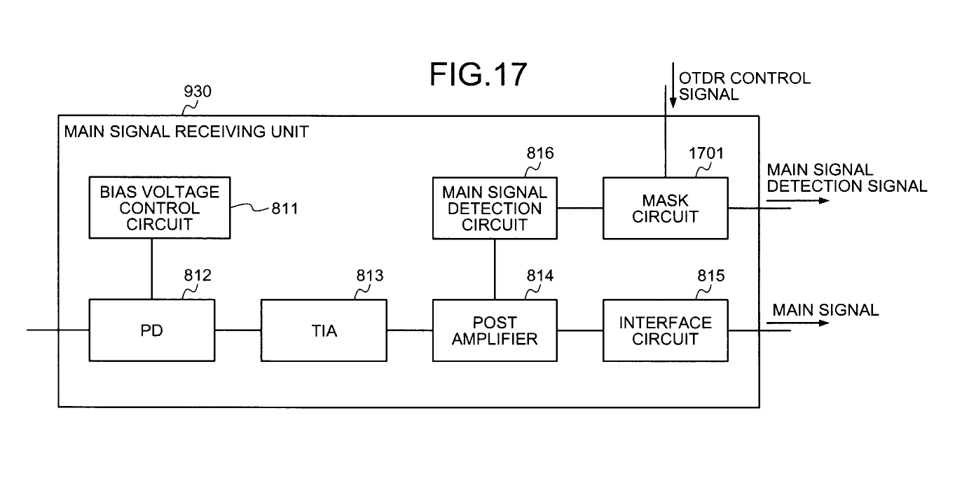

FIG. 17 is a diagram of a modification of the main signal receiving unit. In FIG. 17, portions identical to those depicted in FIG. 8A are denoted by the same reference numerals used in FIG. 8A and will not be described. As depicted in FIG. 17, the main signal receiving unit 930 may further include a mask circuit 1701.

The main signal detection circuit 816 outputs the main signal detection signal to the mask circuit 1701. The main signal detection signal from the main signal detection circuit 816 and the OTDR control signal from the frame control unit 507 are input to the mask circuit 1701. The mask circuit 1701 does not output (masks) the main signal detection signal from the main signal detection circuit 816 during a period of the OTDR area indicated by the OTDR control signal while outputting the main signal detection signal during a period other than the period of the OTDR area (see, e.g., FIGS. 18A and 18B).

Therefore, if the reflected light of the test light sent by the OLT 210 is wrongly detected as the main signal by the main signal detection circuit 816 in the OTDR area in which no main uplink signal is transmitted, the output of the main signal detection signal indicating a false detection result can be avoided.

FIG. 18A is a diagram of an example of the operation timing of the OLT at the normal time. The horizontal axis in FIG. 18A represents time. An uplink frame 1810 represents an uplink frame indicated by uplink frame information output from the frame control unit 507. Data areas 1811 and 1813 of the uplink frame 1810 are periods in which the ONUs 231 to 23n transmit the burst signals 241 to 24n. In the example depicted in FIG. 18A, the data area 1811 is defined between times t1 and t2, and the data area 1813 is defined after time t6.

An OTDR area 1812 of the uplink frame 1810 is a period in which the OLT 210 sends test light to diagnose transmission lines based on the reflected light of the test light. A length of the OTDR area 1812 at the normal time is the time T1 that is twice the longest propagation delay time among the propagation delay times between the ONUs 231 to 23n and the OLT 210. In the example depicted in FIG. 18A, the OTDR area 1812 is defined between times t2 and t6.

An OTDR control signal 1820 indicates the OTDR control signal output from the frame control unit 507. The OTDR control signal 1820 is a signal going high during the period of the OTDR area 1812 of the uplink frame 1810 and low during a period other than the OTDR area 1812.

A test light 1830 represents the test light sent from the test light sending unit 502. The test light 1830 is a pulsed signal transmitted at the timing when the OTDR control signal 1820 changes from low to high.

A sampling control signal 1840 represents the sampling control signal output from the synchronization circuit 1501 (see, e.g., FIG. 15) of the diagnosing unit 506. The sampling control signal 1840 is a signal acquired by delaying the timing of the OTDR control signal 1820 changing from low to high for the sending period of the test light 1830. In the example depicted in FIG. 18A, the sampling control signal 1840 is a signal changing from low to high at time t3 after time t2 and changing from high to low at time t6.

A main signal 1850 represents the main uplink signal received by the OLT 210 and output from the interface circuit 815 depicted in FIG. 8A, for example. Since the burst signals 241 to 24n from the ONUs 231 to 23n are transmitted during the periods of the data areas 1811 and 1813, the main signal 1850 is normally output. On the other hand, since the burst signals 241 to 24n from the ONUs 231 to 23n are not transmitted and the test light sent by the OLT 210 is received during the period of the OTDR area 1812, the main signal 1850 enters an indeterminate state.

A main signal detection signal 1860 represents the main signal detection signal output from the main signal detection circuit 816 depicted in FIGS. 8A and 17, for example. Since the burst signals 241 to 24n from the ONUs 231 to 23n are transmitted during the periods of the data areas 1811 and 1813, the main signal detection signal 1860 is high. On the other hand, since the burst signals 241 to 24n from the ONUs 231 to 23n are not transmitted and the test light sent by the OLT 210 is received during the period of the OTDR area 1812, the main signal detection signal 1860 enters an indeterminate state.

A main signal detection signal 1870 represents the main signal detection signal output from the mask circuit 1701 depicted in FIG. 17, for example. The mask circuit 1701 outputs the main signal detection signal 1860 with the mask used only during the period of the OTDR area 1812. Therefore, the main signal detection signal 1870 is a signal acquired by turning the main signal detection signal 1860 low during the period of the OTDR area 1812.

An intensity measurement result 1880 represents the intensity of the reflected light of the test light measured by the test light intensity measuring unit 505 and stored in the memory 1503. The vertical axis of the intensity measurement result 1880 represents the intensity of the reflected light of the test light (reflected light intensity). The intensity measurement result 1880 is acquired during a sampling time 1881 indicated by the sampling control signal 1840.

FIG. 18B is a diagram of an example of the operation timing of the OLT at the time of the detection of failure. In FIG. 18B, portions identical to those depicted in FIG. 18A are denoted by the same reference numerals used in FIG. 18A and will not be described. As depicted in FIG. 18B, the OTDR area 1812 at the time of the detection of failure is the time T2 that is twice the propagation delay time between the ONU in which the failure occurred among the ONUs 231 to 23n and the OLT 210. The time T2 is less than or equal to the time T1 depicted in FIG. 18A. Therefore, the length of the sampling control signal 1840 also becomes shorter than the example of FIG. 18A, making the sampling time 1881 shorter.

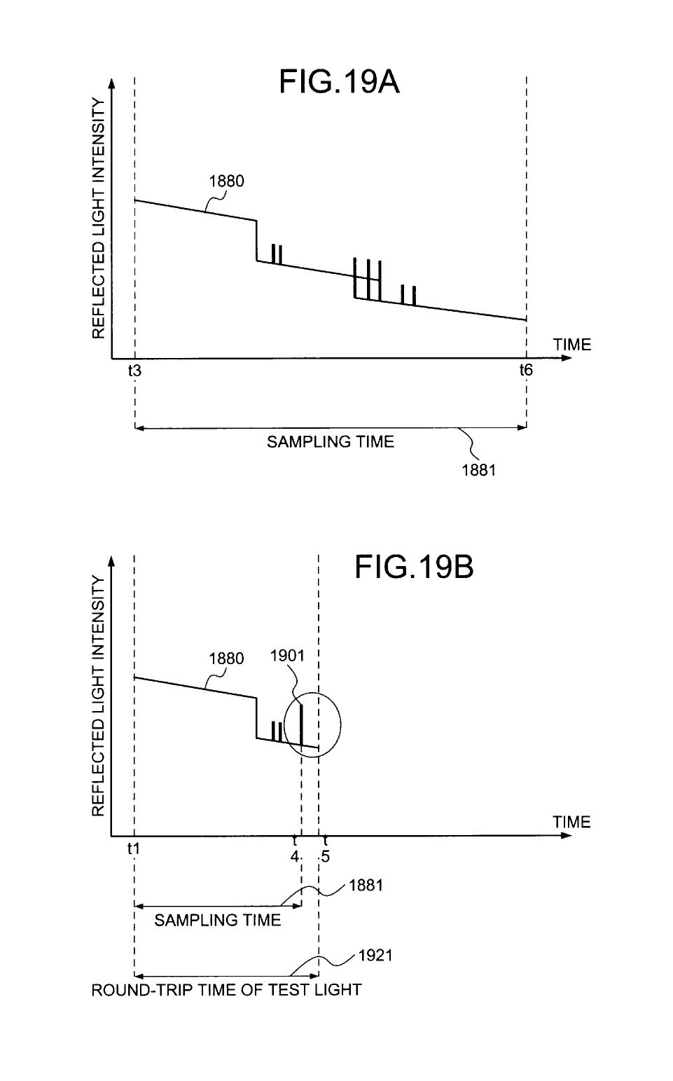

FIG. 19A is a diagram of an example of the intensity measurement result of the reflected light at the normal time. The intensity measurement result 1880 depicted in FIG. 19A is the intensity measurement result of the reflected light in OTDR at the normal time depicted in FIG. 18A.

FIG. 19B is a diagram of an example of the intensity measurement result of the reflected light at the time of the detection of failure. The intensity measurement result 1880 depicted in FIG. 19B is the intensity measurement result of the reflected light in OTDR at the time of the detection of failure depicted in FIG. 18B.

Comparing the intensity measurement result of the reflected light in OTDR at the normal time (FIG. 19A) and the intensity measurement result of the reflected light in OTDR at the time of the detection of failure (FIG. 19B), an intensity 1901 of the reflected light is different at time t4. Therefore, it is understood that a time 1921 from time t1 of the sending of the test light to time t4 corresponds to a round-trip time of the test light between the OLT 210 and the point of failure (e.g., point of line disconnection). Therefore, the diagnosing unit 506 outputs a half of the length of the time 1921 as the propagation distance between the OLT 210 and the point of failure. Therefore, the reflection point of the test light due to the effect of failure can easily be identified.

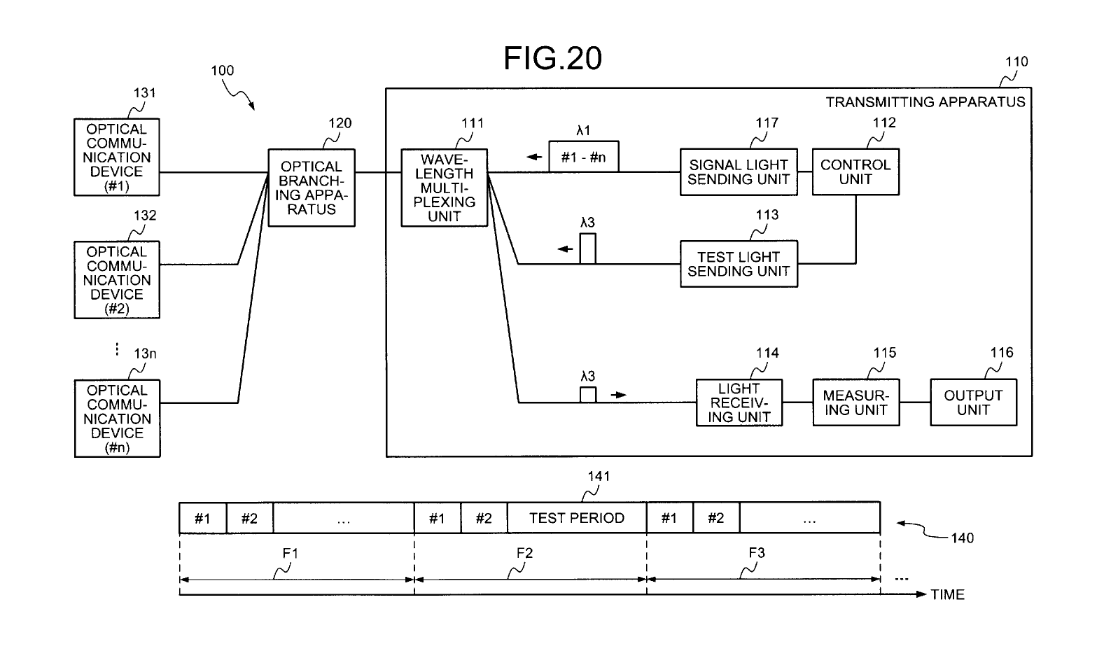

FIG. 20 is a diagram of a modification of the transmitting apparatus. In FIG. 20, portions identical to those depicted in FIG. 1B are denoted by the same reference numerals used in FIG. 1B and will not be described. As depicted in FIG. 20, at the time of the test, the test light sending unit 113 of the transmitting apparatus 110 may send the test light of a wavelength λ3 different from the wavelength λ2 of the optical signals from the optical communication devices 131 to 13n to the transmitting apparatus 110. The wavelength λ3 is a wavelength different from the wavelength λ1 of the optical signal sent by the signal light sending unit 117.

The wavelength multiplexing unit 111 sends to the light receiving unit 114, the light of the wavelength λ2 and the wavelength λ3 among the light sent from the optical branching apparatus 120. The light receiving unit 114 receives the light of the wavelength λ2 and the wavelength λ3 sent from the wavelength multiplexing unit 111. As described above, different wavelengths may be used for the optical signals from the optical communication devices 131 to 13n to the transmitting apparatus 110 and the test light. Even in this case, the transmission lines can be diagnosed without disposing a mechanism of separating the test light from the optical signals from the optical communication devices 131 to 13n by sending the test light to measure the reflected light during the test period 141 while the optical communication devices 131 to 13n are not allowed to transmit optical signals.

As described above, according to the transmitting apparatus and the transmitting method, the transmission lines can be diagnosed while suppressing increase in apparatus scale.

The ratio of the OTDR area in one frame will be described on the assumption that the OTDR area is disposed in all the uplink frames. For example, in XGPON (ITU-TG987.2), the propagation distance of 40 [km] is recommended. When the propagation distance is 40 [km], the time required for a test pulse sent from an OLT to be reflected by an ONU and reach a receiving unit on the OLT side is 267 [μs], for example. Therefore, in a case of a system using a frame of 1 [ms], the OTDR area accounts for ⅓ of the overall transmission frame, increasing the reduction of the transmission rate.

In contrast, for example, the transmission system 100 and the PON system 200 can suppress the reduction of the transmission rate by setting the test period (OTDR area) only in some frames.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A transmitting apparatus connected via an optical branching apparatus to an optical communication device group, the transmitting apparatus comprising:
a control unit that for each periodic transmission period including a first transmission period with a test period in which the optical communication device group is not allowed to transmit optical signals and a second transmission period without the test period, allows the optical communication device group to transmit the optical signals during a period in the periodic transmission period and different from the test period;
a test light sending unit that sends test light to the optical branching apparatus during the test period;
a light receiving unit that receives the optical signals transmitted from the optical communication device group during the period different from the test period, and receives reflected light of the test light sent by the test light sending unit during the test period;
a measuring unit that measures intensity of the reflected light received by the light receiving unit at a plurality of different elapsed times after the sending of the test light during the test period; and
an output unit that outputs information based on the intensity measured at the elapsed times by the measuring unit.

2. The transmitting apparatus according to claim 1, comprising
a signal sending unit that sends optical signals of a first wavelength including signals to the optical communication device group during a period including the test period, wherein
the test light sending unit sends the test light of a second wavelength different from the first wavelength.

3. The transmitting apparatus according to claim 2, wherein
the second wavelength is the wavelength of the optical signals transmitted from the optical communication device group.

4. The transmitting apparatus according to claim 2, comprising a wavelength multiplexing unit that wavelength-multiplexes and sends to the optical branching apparatus, the optical signals of the first wavelength sent by the signal sending unit and the test light of the second wavelength sent by the test light sending unit, and sends to the light receiving unit, the light of the second wavelength included in the light sent from the optical branching apparatus.

5. The transmitting apparatus according to claim 1, comprising a detecting unit that detects failure in transmission lines to the optical communication device group, wherein
the control unit sets the test period in the periodic transmission period upon a detection of failure.

6. The transmitting apparatus according to claim 5, wherein
the control unit sets a length of the test period set upon the detection of failure, based on a propagation time of light to an optical communication device that is among the optical communication device group and corresponds to a transmission line in which the failure is detected.

7. The transmitting unit according to claim 6, wherein
the control unit sets the length of the test period to be twice the length of the propagation time.

8. The transmitting apparatus according to claim 5, wherein
the control unit sets the test period in the transmission period among the periodic transmission periods before the detection of failure, and
the output unit outputs information based on a comparison result between the intensity measured at the elapsed times by the measuring unit during the test period set before detection of the failure and the intensity measured at the elapsed times by the measuring unit during the test period set upon the detection of failure.

9. The transmitting apparatus according to claim 8, wherein
the output unit outputs information that is based on the comparison result and enables identification of a point in the transmission line where the failure occurs.

10. The transmitting apparatus according to claim 8, wherein
the control unit sets the length of the test period set before the detection of failure, based on the longest propagation time among propagation times of light to the optical communication device group.

11. The transmitting apparatus according to claim 10, wherein
the control unit sets the length of the test period set before the detection of failure, to be twice the length of the longest propagation time.

12. The transmitting apparatus according to claim 8, wherein
the control unit periodically sets the test period in the periodic transmission periods before the detection of failure.

13. The transmitting apparatus according to claim 1, wherein
the control unit controls transmission timings of the optical signals of the optical communication device group such that the optical signals from the optical communication device group are received by the light receiving unit at respectively different timings.

14. The transmitting apparatus according to claim 1, wherein
the control unit makes a period for allowing the optical communication device group to transmit optical signals in the first transmission period shorter than a period for allowing the optical communication device group to transmit optical signals in the second transmission period.

15. A transmitting method of a transmitting apparatus connected via an optical branching apparatus to an optical communication device group, the transmitting method comprising:
allowing, for each periodic transmission period including a first transmission period with a test period in which the optical communication device group is not allowed to transmit optical signals and a second transmission period without the test period, the optical communication device group to transmit the optical signals during a period in the periodic transmission period and different from the test period;
sending test light to the optical branching apparatus during the test period;
receiving the optical signals transmitted from the optical communication device group during the period different from the test period, and receiving reflected light of the test light sent during the test period;
measuring intensity of the reflected light received at a plurality of different elapsed times after the sending of the test light during the test period; and
outputting information based on the intensity measured at the elapsed times.
